(19) United States
(12) Patent Application Publication
(10) Pub. No.: US 2005/0138593 A1
(43) Pub. Date: Jun. 23, 2005

(54) Semiconductor integrated circuit having diagonal wires, semiconductor integrated circuit layout method, and semiconductor integrated circuit layout design program

(76) Inventor: Atsuyuki Okumura, Tokyo (JP)

Correspondence Address: DLA PIPER RUDNICK GRAY CARY US, LLP, 2000 UNIVERSITY AVENUE, E. PALO ALTO, CA, 94303-2248, US

(21) Appl. No.: 10/984,326

(22) Filed: Nov. 9, 2004

(30) Foreign Application Priority Data
Nov. 10, 2003 (JP) . P2003-380156

(51) Int. Cl. G06F 17/50

(52) U.S. Cl. 716/13; 716/14

(57) ABSTRACT

A semiconductor integrated circuit includes a plurality of first wires running in a first direction of 0°, a 45° diagonal, a 90° angle and a 135° diagonal in a subject area disposed in a designated wiring layer in a multilevel interconnection; and a plurality of second wires running in a second direction of 0°, the 45° diagonal, the 90° angle and the 135° diagonal in a wiring region other than the designated region in the designated wiring layer.

### CROSS REFERENCE TO RELATED APPLICATIONS

This application is based upon and claims the benefit of priority from the prior Japanese Patent Applications No. P2003-380156, filed on Nov. 10, 2003; the entire contents of which are incorporated herein by reference.

### BACKGROUND OF THE INVENTION

1. Field of the Invention

The present invention relates to a semiconductor integrated circuit, in which logic blocks are made of placed transistors, cells, megacells and the like, and the logic blocks are connected via pins with diagonal wires.

2. Description of the Related Art

Wires intersect with each other in a semiconductor integrated circuit since multiple pins of the logic blocks made up of transistors, cells, megacells and the like are connected by wires. Therefore the semiconductor integrated circuit includes multiple wiring layers, and wires are provided in those wiring layers. Such wires intersect in different wiring layers.

Typically, wiring directions of the wires to be provided in each wiring layer are fixed vertically or horizontally. A wiring direction fixed in one direction is called a priority wiring direction. Wires are laid based on the priority wiring direction for the sake of convenience when designing the wiring layout between pins. When designing orthogonal wires with vertical and horizontal wiring directions, defining either the vertical or horizontal priority wiring direction for each wiring layer facilitates intersecting wires that run in different directions and reduces the time for designing wires.

Furthermore, there is a semiconductor integrated circuit in which wires are laid in at least four wiring layers by defining four wiring directions including vertical, horizontal, a 45° angle, and a 135° angle as priority wiring directions for respective wiring layers.

With the semiconductor integrated circuit in which wires are laid in multiple wiring layers by defining the four wiring directions including vertical, horizontal, a 45° angle, and a 135° angle as priority wiring directions, there is great demand for vertical and horizontal wiring located within wiring regions near memory macrocells and the like, but little demand for wiring arranged at a 45° diagonal and a 135° diagonal. However, only wiring layers with a vertical priority wiring direction can be used for vertical wires, and vertical wires that cannot be included in wiring layers with a vertical priority wiring direction are formed into zigzag wires in wiring layers with priority wiring directions at a 45° diagonal and a 135° diagonal. As a result, the wire length is excessively increased.

If a priority wiring direction is not defined for each wiring layer, a method allowing wires in a wiring layer to be vertical and horizontal in the case of orthogonal wires is available, otherwise the vertical, horizontal, 45° angle and 135° angle in the case of diagonal wires cannot arrange wires in a large-scale semiconductor integrated circuit within a practical processing time since calculations for obtaining wiring paths increases.

### SUMMARY OF THE INVENTION

An aspect of the present invention inheres in a semiconductor integrated circuit including a plurality of first wires running in a first direction of 0°, a 45° diagonal, a 90° angle and a 135° diagonal in a subject area disposed in a designated wiring layer in a multilevel interconnection; and a plurality of second wires running in a second direction of 0°, the 45° diagonal, the 90° angle and the 135° diagonal in a wiring region other than the designated region in the designated wiring layer.

Another aspect of the present invention inheres in a method for routing a wire within a semiconductor integrated circuit including placing a logic block in a layout plane that includes a plurality of wiring layers; defining an initial area across the entire layout plane; designating a wiring direction for each of the wiring layers within the initial area; defining a re-designated region within the initial area; changing the wiring direction for each of the wiring layers in the re-designated region; and forming wires in the wiring layers based on the wiring directions.

Still another aspect of the present invention inheres in a method for routing a wire within a semiconductor integrated circuit including placing a logic block in a layout plane that includes a plurality of wiring layers; defining an initial area across the entire layout plane; designating a wiring direction for each of the wiring layers within the initial area; forming initial wires in the wiring layers based on the wiring directions; determining whether the initial wires are detour wires; designating a region between pins that are connected by detour wires within the initial area as a re-designated region when the initial wires are the detour wires; changing the wiring direction for each of the wiring layers in the re-designated region; and forming re-formed wires in the wiring layers based on the changed wiring directions.

Still another aspect of the present invention inheres in a computer program product for routing a wire within a semiconductor integrated circuit which includes instructions for placing a logic block in a layout plane that includes a plurality of wiring layers; instructions for defining an initial area across the entire layout plane; instructions for designating a wiring direction for each of the wiring layers within the initial area; instructions for defining a re-designated region within the initial area; instructions for changing the wiring direction for each of the wiring layers in the re-designated region; and instructions for forming wires in the wiring layers based on the wiring directions.

Still another aspect of the present invention inheres in a computer program product for routing a wire within a semiconductor integrated circuit which includes instructions for placing a logic block in a layout plane that includes a plurality of wiring layers; instructions for defining an initial area across the entire layout plane; instructions for designating a wiring direction for each of the wiring layers within the initial area; instructions for forming initial wires in the wiring layers based on the wiring directions; instructions for determining whether the initial wires are detour wires; instructions for designating a region between pins that are connected by detour wires within the initial area as a re-designated region when the initial wires are the detour wires; instructions for changing the wiring direction for each of the wiring layers in the re-designated region; and instructions for forming re-formed wires in the wiring layers based on the changed wiring directions.

### BRIEF DESCRIPTION OF THE DRAWINGS

FIG. 1 is a block diagram of a design apparatus for a semiconductor integrated circuit according to a first embodiment;

FIG. 2 is a flowchart of a design method for the semiconductor integrated circuit according to the first embodiment;

FIG. 3 is a flowchart of a layout design method for the semiconductor integrated circuit according to the first embodiment;

FIG. 4 is a schematic of a mid-design layout of the semiconductor integrated circuit according to the first embodiment;

FIG. 5 is a table representing a database of wiring layers within an initial designated region and wiring directions thereof;

FIG. 6 is a diagram of wires based on the wiring layers within the initial designated region and wiring directions thereof;

FIG. 7 is a schematic of a mid-design layout of the semiconductor integrated circuit according to the first embodiment;

FIGS. 8 and 9 are tables representing databases of wiring layers within re-designated regions and wiring directions thereof before and after changes; FIG. 8 relates to wiring directions of a wiring layer above a megacell located in a corner of an oblong semiconductor integrated circuit; and FIG. 9 relates to wiring directions of a wiring layer within a re-designated region adjacent to the megacell located in a corner of the oblong semiconductor integrated circuit;

FIG. 10 is a diagram of wires based on wiring layers within a re-designated region adjacent to the megacell located in a corner of the oblong semiconductor integrated circuit and within a re-designated region on the megacell located in a corner of the oblong semiconductor integrated circuit and wiring directions thereof;

FIG. 11 is a table representing a database of wiring layers within a re-designated region and wiring directions thereof before and after changes, and relates to wiring directions of the wiring layers above the re-designated region adjacent to a megacell located in the center of the semiconductor integrated circuit;

FIG. 12 is a diagram of wires based on wiring layers within a re-designated region adjacent to the megacell located in the center of the semiconductor integrated circuit and wiring directions thereof;

FIGS. 13 through 16 are tables representing databases of wiring layers within re-designated regions and wiring directions thereof before and after changes; FIG. 13 relates to wiring directions of wiring layers within a re-designated region above a megacell located in the center of a semiconductor integrated circuit; FIG. 14 relates to wiring directions of wiring layers within a re-designated region above a megacell located at a side of the semiconductor integrated circuit; FIG. 15 relates to wiring directions of wiring layers within a re-designated region defined in a corner of the semiconductor integrated circuit in which there is no megacell; and FIG. 16 relates to wiring directions of wiring layers within a re-designated region defined at a side of the semiconductor integrated circuit at which there is no megacell;

FIG. 17 is a flowchart of a layout design method for a semiconductor integrated circuit according to a second embodiment;

FIG. 18 is a table representing a database of wiring layers within a re-designated region and wiring directions thereof before and after changes;

FIGS. 19 through 22 are wiring diagrams of a mid-design layout of the semiconductor integrated circuit according to the second embodiment;

FIG. 23 is a top view of a schematic layout of a semiconductor integrated circuit according to a third embodiment;

FIG. 24 is a cross section of a schematic layout of the semiconductor integrated circuit according to the third embodiment; and

FIG. 25 is a table representing a database of wiring layers within an initial designated region and wiring directions thereof;

FIGS. 26 through 29 are top views of a layout of the semiconductor integrated circuit according to the third embodiment.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

### FIRST EMBODIMENT

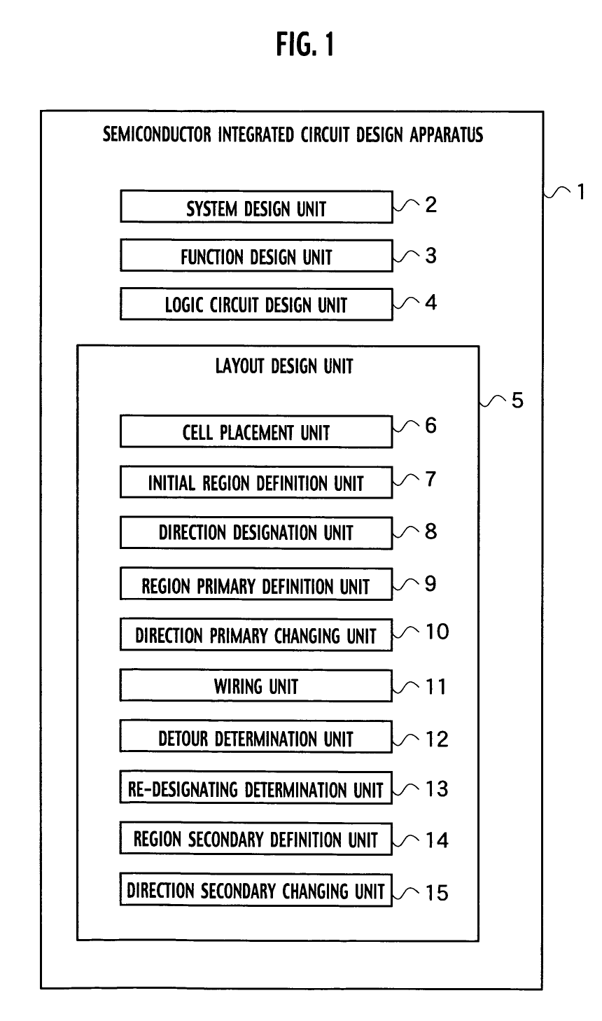

A design unit 1 for a semiconductor integrated circuit according to a first embodiment of the present invention, as shown in FIG. 1, includes a system design unit 2, a function design unit 3, a logic circuit design unit 4, and a layout design unit 5. The layout design unit 5 includes a cell placement unit 6, an initial region definition unit 7, a direction designation unit 8, a region primary definition unit 9, a direction primary changing unit 10, a wiring unit 11, a detour determination unit 12, and a re-designating determination unit 13. Note that the design unit 1 of the semiconductor integrated circuit may be a computer, or it may be implemented by making the computer execute a procedure specified by a program.

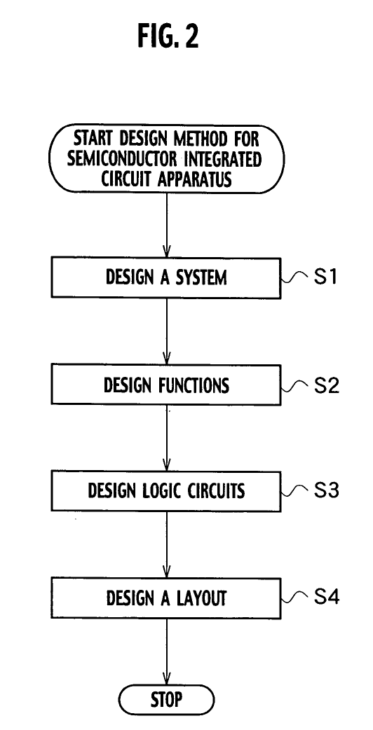

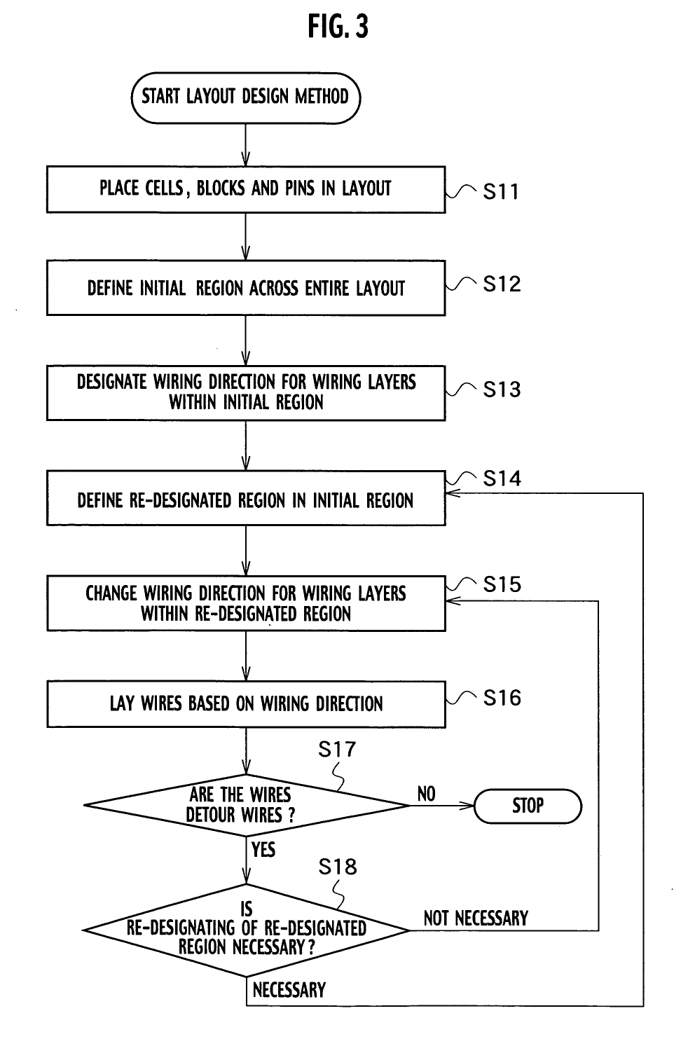

With a design method for the semiconductor integrated circuit according to the first embodiment of the present invention, as shown in FIG. 2, to begin with in step S1, the system design unit 2 designs a system including the semiconductor integrated circuit. In step S2, the function design unit 3 designs functions required by the semiconductor integrated circuit based on the system. In step S3, the logic circuit design unit 4 designs logic circuits of the semiconductor integrated circuit based on these functions. In step S4, the layout design unit 5 designs a semiconductor integrated circuit layout based on these logic circuits. With these steps, the design method for the semiconductor integrated circuit is completed. Note that details of step S4 are in the following description regarding the semiconductor integrated circuit layout design method of FIG. 3. The semiconductor integrated circuit design method may be expressed as a procedure by a computer-executable semiconductor integrated circuit design program. Executing this semiconductor integrated circuit design program by a computer allows implementation of the semiconductor integrated circuit design method.

An overview of the layout design method for the semiconductor integrated circuit according to the first embodiment of the present invention is described.

To begin with, in step S11 of FIG. 3, the cell placement unit 6 places transistors, cells and megacells in a layout plane. The layout plane includes multiple wiring layers.

Next, in step S12, the initial region definition unit 7 defines an initial designated region across the entire layout plane.

In step S13, the direction designation unit 8 designates wiring directions for the wiring layers within the initial designated region.

In step S14, the region primary definition unit 9 designates a re-designated region within the initial designated region.

In step S15, the direction primary changing unit 10 changes the wiring directions for the wiring layers within the re-designated region based on a prerecorded database.

In step S16, the wiring unit 11 forms wires connecting pins via the wiring layers based on the wiring directions.

In step S17, the detour determination unit 12 determines whether the wires are detour wires. If the wires are not detour wires, this process based on the layout design method for the semiconductor integrated circuit stops. Processing proceeds to step S18 if the wires are detour wires. To determine whether wires are detour wires, whether the wire length is equal to or greater than the distance between connected pins should be determined. Otherwise, if there is a branch point along the wire, whether the said wire length is equal to or greater than the product of the square root of two and either the distance between a connected pin and a wire branch point or distance between wire branch points should be determined. Preferably, it should be determined that the wire length is at least the product of the distance (multiplicand) between connected pins and 1.3 (multiplier). More preferably, it should be determined whether the wire length is at least the product of the distance (multiplicand) between connected pins and 1.2 (multiplier). In other words, the closer the multiplier approaches one, the shorter the detour can become. However, since time is needed for repeating wiring so as to delete detour wires, the multiplier should approach one within the allowable time for repeating wiring.

In step S18, the re-designating determination unit 13 determines whether or not designating a re-designated region needs to be re-implemented. Processing proceeds to step S14 if it is determined that re-designating is necessary. Processing proceeds to step S15 if it is determined that re-designating is unnecessary. Re-designating is determined to be necessary in the case where detour wires are located outside of the re-designated region. Re-designating is determined to be necessary in the case where the pins connecting to the detour wires are located outside of the re-designated region. Re-designating is determined to be unnecessary in the case where detour wires are located throughout the re-designated region. In the case where detour wires are located within a part of the re-designated region, it is necessary to designate a newly re-designated region within the re-designated region.

The layout design method for the semiconductor integrated circuit according to the first embodiment of the present invention is described based on a specific example.

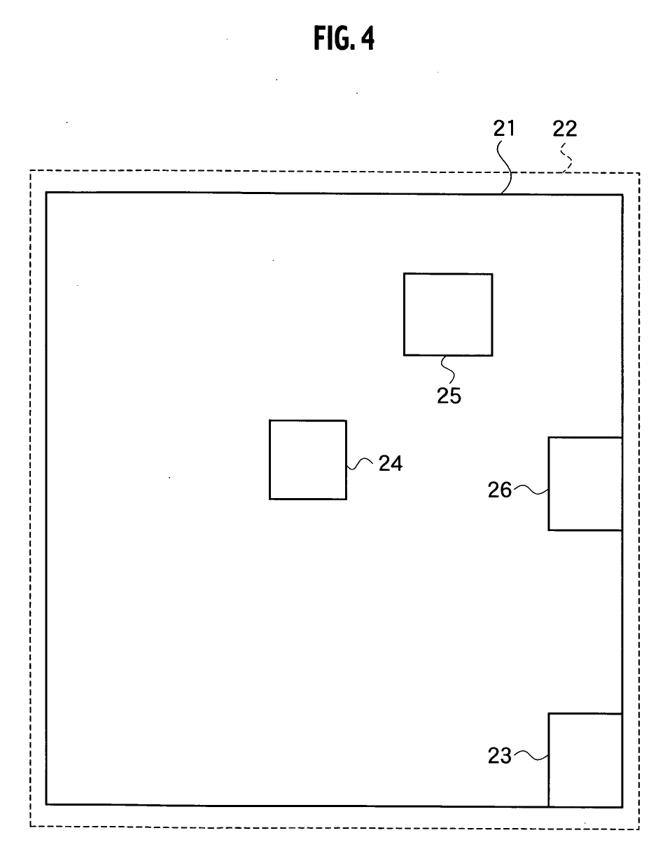

To begin with, in step S11 of FIG. 3, as shown in FIG. 4, transistors, cells and megacells 23 to 26 are placed in an oblong layout plane 21. The layout plane 21 includes multiple wiring layers.

Next, in step S12, an initial designated region 22 is defined across the entire layout plane 21.

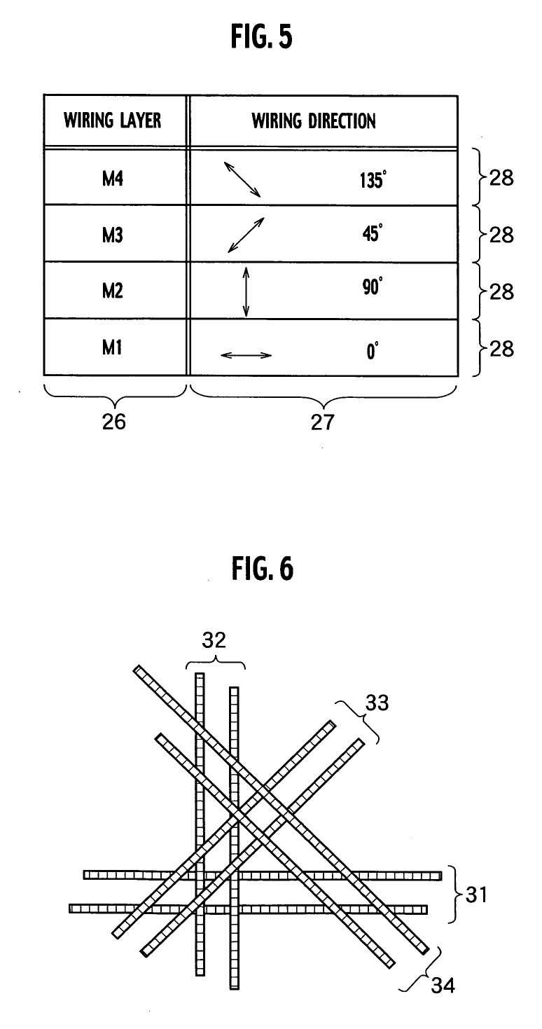

In step S13, wiring directions are designated for the wiring layers within the initial designated region 22. Specifically, a database searchable for wiring directions based on such wiring layers as shown in FIG. 5 is created. The database includes records 28 searchable for wiring directions based on designated wiring layers. The records 28 each include a wiring layer field 26 and a wiring direction field 27. Accordingly, a wiring direction at 0° (horizontal) from a first wiring layer can be retrieved. Similarly, a wiring direction at a 90° angle (vertical), 45° diagonal and 135° diagonal from second through fourth wiring layers can be retrieved. According to such retrieval, as shown in FIG. 6, wires 31 can be arranged in the first wiring layer with a 0° wiring direction. Wires 32 can be arranged in the second wiring layer with a 90° wiring direction. Wires 33 can be arranged in the third wiring layer with a 45° wiring direction. Wires 34 can be arranged in the fourth wiring layer with a 135° wiring direction.

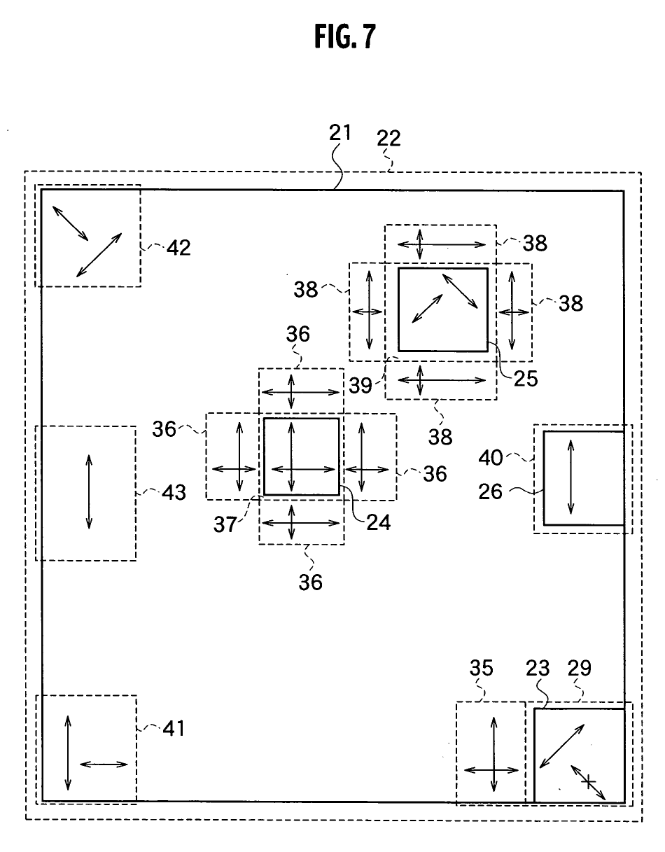

In step S14, as shown in FIG. 7, re-designated regions 29 and 35 through 43 are designated within the initial designated region 22. The re-designated region 29 is provided within a region overlapping the cell 23, which is located in a corner of the layout plane 21. The re-designated region 35 is provided within a region adjacent to the cell 23, which is located in a corner of the layout plane 21. The re-designated region 37 is provided within a region overlapping the cell 24, which is located in the center of the layout plane 21. The re-designated regions 36 are provided within regions adjacent to the-cell 24, which is located in the center of the layout plane 21. The re-designated region 39 is provided within a region overlapping the cell 25, which is located in the center of the layout plane 21. The re-designated regions 38 are provided within regions adjacent to the cell 25, which is located in the center of the layout plane 21. The re-designated region 40 is provided within a region overlapping the cell 26, which is located along an oblong side of the layout plane 21. The re-designated regions 41 and 42 are provided in corners of the layout plane 21 in which there are no megacells. The re-designated region 43 is provided on a side of the layout plane 21 on which there is no megacell.

In step S15, the wiring directions of the wiring layers within the re-designated regions 29 and 35 through 43 are changed based on a prerecorded database.

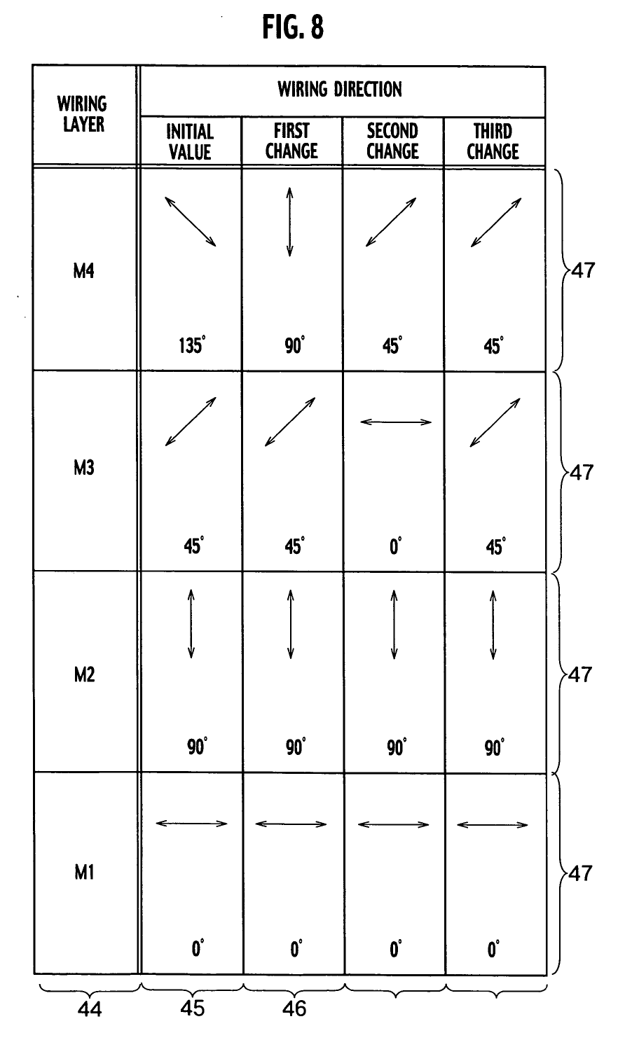

A database as shown in FIG. 8 is prepared ahead of time for the re-designated region 29. The database is searchable for wiring directions before and after changes based on wiring layers. The database includes records 47 searchable for wiring directions before and after changes based on designated wiring layers. The records 47 each include a wiring layer field 44, an initial wiring direction field 45, and first, second and third changed wiring direction fields 46. With the first change, wiring directions for the first through fourth wiring layers before and after changes can be retrieved. It can be seen that the wiring directions for the first through third wiring layers do not change before and after the first change. It can also be seen that the wiring direction for the fourth wiring layer is changed from a 135° diagonal to a 90° angle before and after the first change. It can also be seen that the wiring direction for the third wiring layer is changed from a 45° diagonal to a 0° angle before and after the second change. It can also be seen that the wiring direction for the fourth wiring layer is changed from a 90° angle to a 45° diagonal before and after the second change. It can also be seen that the wiring direction for the third wiring layer is changed from 0° to a 45° diagonal before and after the third change. It is conceivable that the first change is proper when mega cell 23 is rectangle with the vertical side longer than the horizontal side. It is conceivable that the second change is proper when mega cell 23 is rectangle with the horizontal side longer than the vertical side. It is conceivable that the third change is proper when mega cell 23 is square.

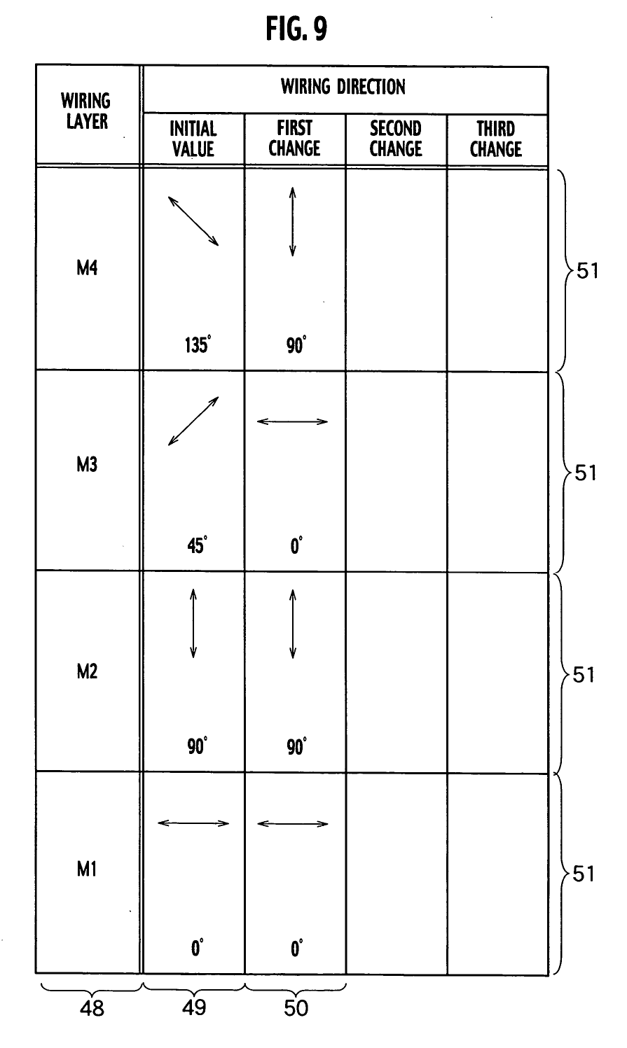

A database as shown in FIG. 9 is prepared ahead of time for the re-designated region 35. The database is searchable for wiring directions before and after changes based on wiring layers. The database includes records 51 searchable for wiring directions before and after changes based on designated wiring layers. The records 51 each include a wiring layer field 48, an initial wiring direction field 49, and a first changed wiring direction field 50. With the first change, wiring directions for the first through fourth wiring layers before and after changes can be retrieved. It can be seen that the wiring directions for the first and second wiring layers do not change before and after the change. It can also be seen that the wiring direction for the third wiring layer is changed from a 45° diagonal to 0°. It can also be seen that the wiring direction for the fourth wiring layer is changed from a 135° diagonal to a 90° angle.

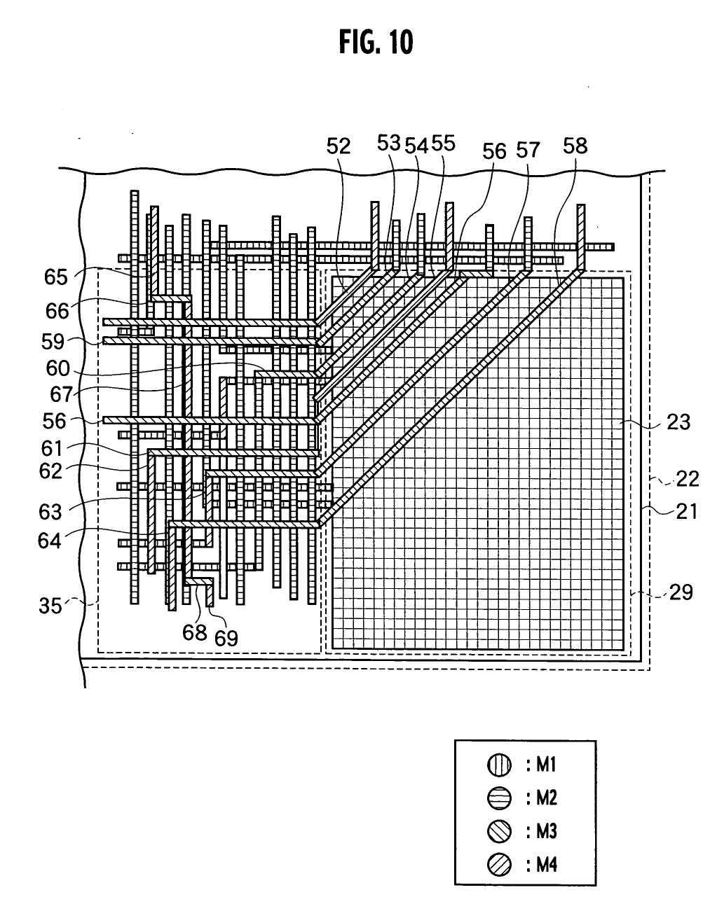

In step S16, as shown in FIG. 10, regarding the re-designated regions 29 and 35, wires connecting pins via the wiring layers based on the wiring directions in the databases of FIG. 8 and FIG. 9 are formed. In the case where the megacell 23 is internally wired with the first and second wiring layers when fabricating passing wires over the megacell 23 located in a corner of the layout plane 21, wires may be formed in the third wiring layer and higher layer over the megacell 23. The wiring directions for the third and fourth wiring layers within the re-designated region 29 are at the same 45° diagonal as shown with the first change in FIG. 8. The wiring directions for the third and fourth wiring layers are defined at a 135° diagonal due to the position of the corner of the layout plane 21 in which the megacell 23 is located. Not only the wires 53, 54, and 56 through 58 in the third layer, but the wires 52 and 55 in the fourth layer may also pass over the megacell 23 at a short distance. The wiring directions for the successive third and fourth wiring layers need not always be different in this manner, and may be the same.

Furthermore, there is little demand for wires with wiring directions at a 45° diagonal and a 135° diagonal when fabricating wires within the re-designated region 35, which is adjacent to the megacell 23 located in a corner of the layout plane 21. Therefore, the wiring direction for the third wiring layer within the re-designated region 35 has been changed from a 45° diagonal to 0°. Similarly, the wiring direction for the fourth wiring layer has been changed from a 135° diagonal to a 90° angle. As shown in FIG. 10, the wiring direction for the third layer wirings 56, 59, 60, 61, 66, and 68 is at 00. The wiring direction for the fourth layer wirings 62, 63, 64, 65, 67, and 69 is at a 90° angle.

In this manner, since multiple wiring directions exist for a single wiring layer, many wiring layers may be used for the wiring directions most required for connection. A short wire length can be obtained, and the wire length does not become longer than necessary. Furthermore, since the number of the detour wires decrease and the connection rate improves under the condition of the priority wiring direction for each region in each wiring layer being fixed when laying wires, wires can be designed within a practical processing time.

Next, the re-designated regions 36 and 38 of FIG. 7 are described.

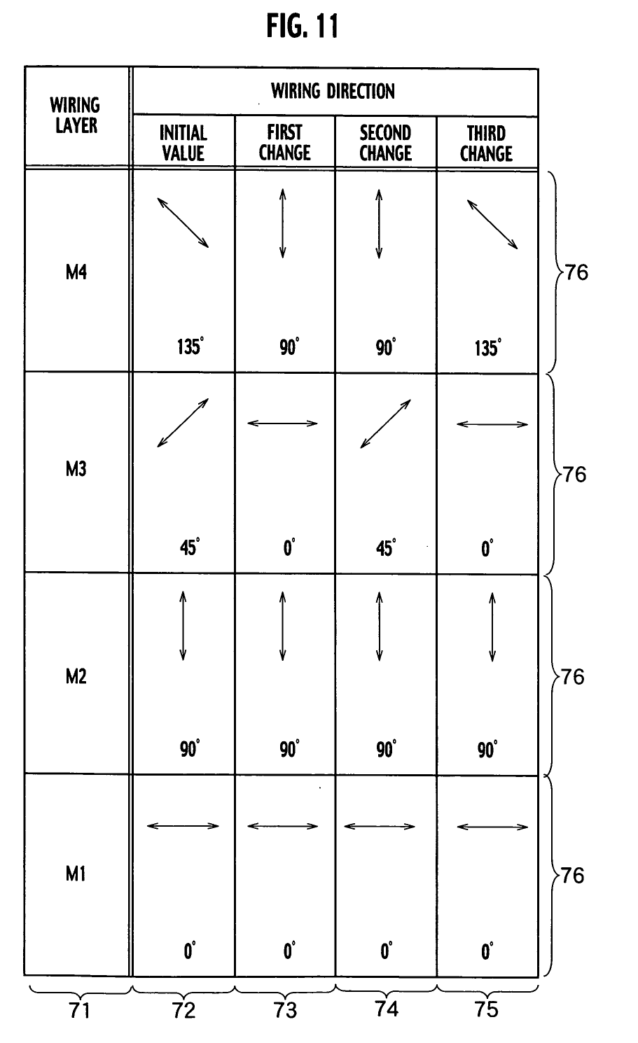

In step S15, the wiring directions for the wiring layers within the re-designated regions 36 and 38 are changed. A database as shown in FIG. 11 is prepared ahead of time for the re-designated regions 36 and 38. The database is searchable for wiring directions before and after changes based on wiring layers. The database includes records 76 searchable for wiring directions before and after changes based on designated wiring layers. The records 76 each include a wiring layer field 71, an initial wiring direction field 72, a first changed wiring direction field 73, a second changed wiring direction field 74, and a third changed wiring direction field 75. First through third changes are possible and wiring directions for the first through fourth wiring layers before and after changes can be retrieved. It can be seen that the wiring directions for the first and second wiring layers do not change before and after the change. It can be seen that with the first change, the wiring direction for the third wiring layer changes to 0°, and the wiring direction for the fourth wiring layer changes to a 90° angle. It can also be seen that with the second change, the wiring direction for the third wiring layer changes to a 45° diagonal, and the wiring direction for the fourth wiring layer remains at a 90° angle. It can be seen that with the third change, the wiring direction for the third wiring layer changes to 0°, and the wiring direction for the fourth wiring layer also changes to a 135° diagonal. Like this, the wiring directions of two adjoining layers are set up as the wiring directions different from each other.

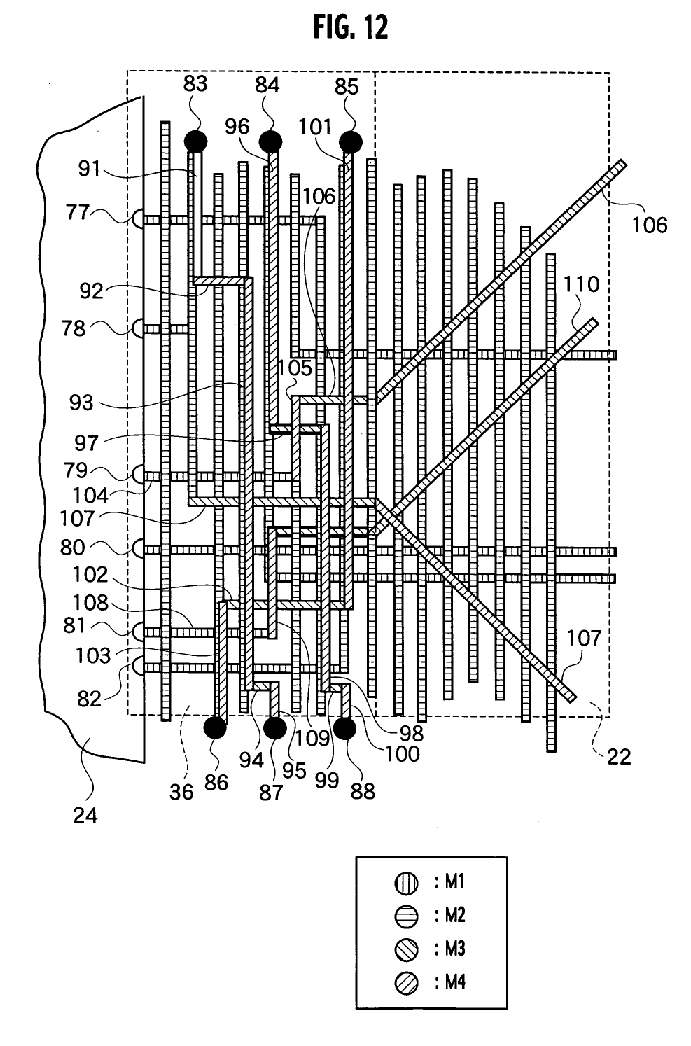

In step S16, as shown in FIG. 12, regarding the re-designated regions 36 and 38, wires connecting pins via the wiring layers based on the first changed wiring direction in the database of FIG. 11 are formed. There is little demand for wires with wiring directions at a 45° diagonal and a 135° diagonal when fabricating wires within the re-designated region 35, which is adjacent to the megacells 24 and 25 located in the center of the layout plane 21. On the other hand, the wiring directions for the wires 104 and 108 connected to pins 77 through 82 of the megacells 24 and 25 are in a direction perpendicular to a certain side of the pins 77 through 82 of the megacell 24 connected by the wirings 104 and 108, and 0° of FIG. 12, respectively. Moreover, the 90° angle wires 91, 93, 95, 96, 98, 100, 101, and 103 running in a wiring direction parallel to a side of the megacells 24 and 25 in FIG. 12 are required. This is because wires running in a wiring direction parallel to a side do not connect with the megacells 24 and 25. With the first change, therefore, the wiring direction for the third wiring layer within the re-designated regions 36 and 38 has been changed to 0° as shown in FIG. 11. Similarly, the wiring direction for the fourth wiring layer has been changed to a 0° angle. As shown in FIG. 12, the wiring direction for the third layer wirings 92, 94, 97, 99 and 102 is at 0°. The wiring direction for the fourth layer wirings 91, 93, 95, 96, 98, 100, 101, and 103 is at a 90° angle.

In this manner, since multiple wiring directions exist for a single wiring layer, many wiring layers may be used for the wiring directions most required for connection. A short wire length can be achieved, and the wire length does not become longer than necessary. Furthermore, since the connection rate improves based on the condition of the priority wiring direction for each region in each wiring layer being fixed when laying wires, wires can be designed within a practical processing time.

The semiconductor integrated circuit fabricated based on the designed layout, as shown in FIGS. 7 and 12, includes a semiconductor substrate 21, transistors, cells, megacells 23 through 26, which have pins 77 through 88, and wires 91 through 106, which connect between the pins 77 through 88. The transistors, cells or megacells 23 through 26 are placed on the surface of the semiconductor substrate 21. Multiple wiring layers are arranged in layers over the semiconductor substrate 21. The initial designated region 22 is defined across the entirety of each wiring layer, and the re-designated regions 29 and 35 through 43 are defined within regions in which the wiring layers within the initial designated region 22 mutually overlap. The wiring directions within the initial designated region 22 and the wiring directions for the re-designated regions 29 and 35 through 43 differ for every wiring layer. The wires 91 through 106 connect between the pins 77 through 88 via the initial designated region 22 and the re-designated regions 29 and 35 through 43 with multiple wiring layers.

In step S17, it is determined whether successive wires 91 through 95 are detour wires. In order to determine whether the successive wires 91 through 95 are detour wires, it is determined whether the sum of the lengths of the successive wires 91 through 95 is equal to or greater than the product of the distance (multiplicand) between the connected pins 83 through 87 and the square root of two (multiplier). Similarly, regarding successive wires 96 through 100, it is determined whether the sum of the lengths of the successive wires 96 through 100 is equal to or greater than the product of the distance (multiplicand) between the connected pins 84 through 88 and the square root of two (multiplier). Regarding successive wires 101 through 103, it is determined whether the sum of the lengths of the successive wires 101 through 103 is equal to or greater than the product of the distance (multiplicand) between the connected pins 85 through 86 and the square root of two (multiplier). If all of the successive wires 91 through 95, 96 through 100, and 101 through 103 are not detour wires, this process based on the layout design method for the semiconductor integrated circuit stops. If all of the successive wires 91 through 95, 96 through 100, and 101 through 103 are detour wires, processing proceeds to step S18.

In step S18, it is determined whether designating the re-designated regions 36 and 38 is needed again. Processing proceeds to step S14 if it is determined that re-designating is necessary. Processing proceeds to step S15 if it is determined that re-designating is unnecessary.

In step S15 for a second time, the wiring directions for the wiring layers within the re-designated regions 36 and 38 are changed based on the second changed wiring direction in the database of FIG. 11. Similarly, in step S15 a third time, the wiring directions for the wiring layers within the re-designated regions 36 and 38 are changed based on the third changed wiring direction in the database of FIG. 11.

Next, the re-designated regions 37 and 39 of FIG. 7 are described.

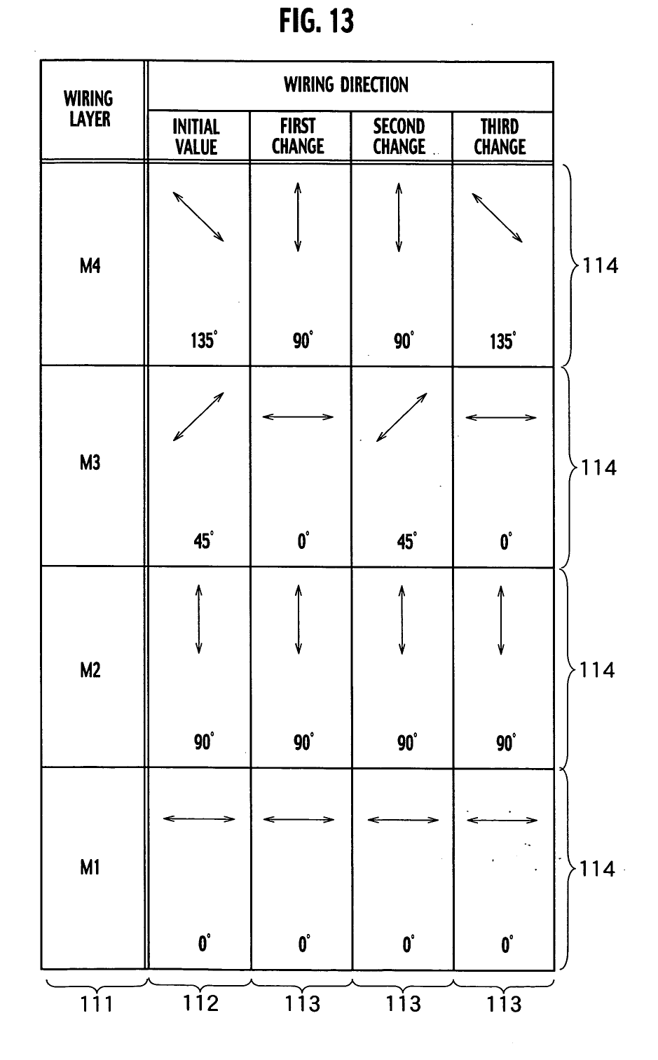

In step S15, the wiring directions for the wiring layers within the re-designated regions 37 and 39 are changed. A database as shown in FIG. 13 is prepared ahead of time for the re-designated regions 37 and 39. The database is searchable for wiring directions before and after changes based on wiring layers. The database includes records 114 searchable for wiring directions before and after changes based on designated wiring layers. The records 114 each include a wiring layer field 111, an initial wiring direction field 112, and a first changed wiring direction field 113. With this, the first change is possible, and wiring directions for the first through fourth wiring layers before and after changes can be retrieved. It can be seen that the wiring directions for the first and second wiring layers do not change before and after changes. It can be seen that with the first change, the wiring direction for the third wiring layer changes to 0°, and the wiring direction for the fourth wiring layer changes to a 90° angle. Note that the second change is employed in the case of detour wires being developed with the first change, and the third change is employed in the case of detour wires being developed with the second change. In the case of detour wires being developed with the third change, it may be changed to the initial value as the fourth change.

Reasons for the above changes are described. In the case where the megacells 24 and 25 are internally wired with the first and the second wiring layer, passing wires may be formed in the third wiring layer or higher over the megacells 24 and 25 located in the center of the layout plane 21. The wiring direction for the third wiring layer within the re-designated region 37 and 39 is at 0° as shown with the first change of FIG. 13, and the wiring direction for the fourth wiring layer is at a 90° angle. As combinations of wiring directions for wires passing over the megacells 24 and 25, combinations of 0° and a 90° angle, a 45° diagonal and a 135° diagonal, a 90° angle and a 45° diagonal, 0° and a 135° diagonal, a 135° diagonal and a 90° angle, and 0° angle and a 45° diagonal can be considered. This is because the wiring directions for the third and fourth layers need not necessarily be orthogonal.

Next, the re-designated region 40 of FIG. 7 is described.

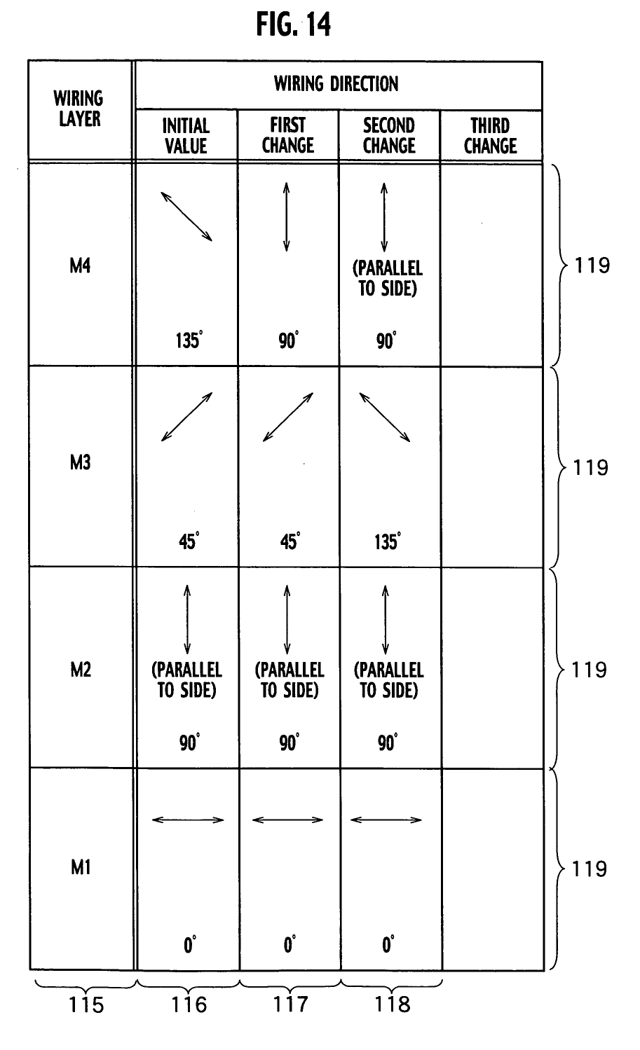

In step S15, the wiring directions for the wiring layers within the re-designated region 40 are changed. A database as shown in FIG. 14 is prepared ahead of time for the re-designated region 40. The database is searchable for wiring directions before and after changes based on wiring layers. The database includes records 119 searchable for wiring directions before and after changes based on designated wiring layers. The records 114 each include a wiring layer field 115, an initial wiring direction field 116, a first changed wiring direction field 117, and a second changed wiring direction field 118. With this, the first change and second change are possible, and wiring directions for the first through fourth wiring layers before and after changes can be retrieved. It can be seen that the wiring directions for the first and second wiring layers do not change before and after the change. It can be seen that with the first change, the wiring direction for the fourth wiring layer changes to a direction parallel to a side of the layout plane 21 or a 90° angle. Note that in the case of detour wires being developed with the first change, the wiring direction is changed based on the second change. It can also be seen that the wiring direction for the third wiring layer is changed to a 135° diagonal before and after the second change. In this manner, the wiring directions of two adjoining layers are set up as wiring directions different from each other.

The reasons for such changes are described. In the case where the megacell 26 is internally wired with the first and the second wiring layer, passing wires may be formed in the third wiring layer or higher over the megacell 26 located on a side of the layout plane 21. As the wiring directions for the wires passing over the megacell 26, a direction parallel to the side on which the megacell 26 is placed or a 90° angle can be considered.

Next, the re-designated regions 41 and 42 of FIG. 7 are described.

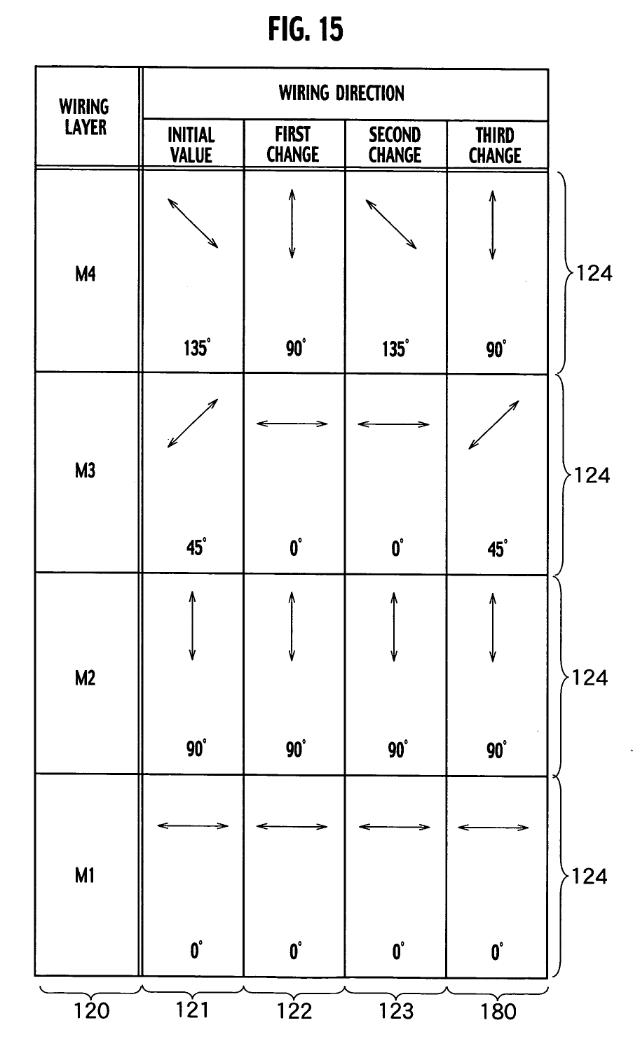

In step S15, the wiring directions for the wiring layers within the re-designated regions 41 and 42 are changed. A database as shown in FIG. 15 is prepared ahead of time for the re-designated regions 41 and 42. The database is searchable for wiring directions before and after changes based on wiring layers. The database includes records 124 searchable for wiring directions before and after changes based on designated wiring layers. The records 124 each include a wiring layer field 120, an initial wiring direction field 121, a first changed wiring direction field 122, a second changed wiring direction field 123, and a third changed wiring direction field 180. With this process, the first through third changes are possible, and wiring directions for the first through fourth wiring layers before and after changes can be retrieved. It can be seen that with the first change, the wiring direction for the third wiring layer changes to 0°, and the wiring direction for the fourth wiring layer changes to a 90° angle. Note that in the case of detour wires being developed with the first change, the wiring direction is changed based on the second change. It can be seen that with the second change, the wiring direction for the fourth wiring layer changes to a 135° angle. In the case of detour wires being developed with the second change, the wiring direction is changed based on the third change. It can be seen that with the third change, the wiring direction for the third wiring layer changes to a 45° angle, and the wiring direction for the fourth wiring layer changes to a 90° angle. The reasons for such changes are described. As combinations of wiring directions for wirings required by the re-designated regions 41 and 42, which are arranged in corners of the layout plane 21 in which megacells are not located, combinations of 0° and a 90° angle and a 45° diagonal and a 135° diagonal can be considered. Since standard cells are placed within the re-designated regions 41 and 42, wires at a 45° angle and a 135° angle are not used in the first layer and the second layer. Furthermore, the wiring directions in the third layer and the fourth layer need not always be orthogonal.

Next, the re-designated region 43 of FIG. 7 is described.

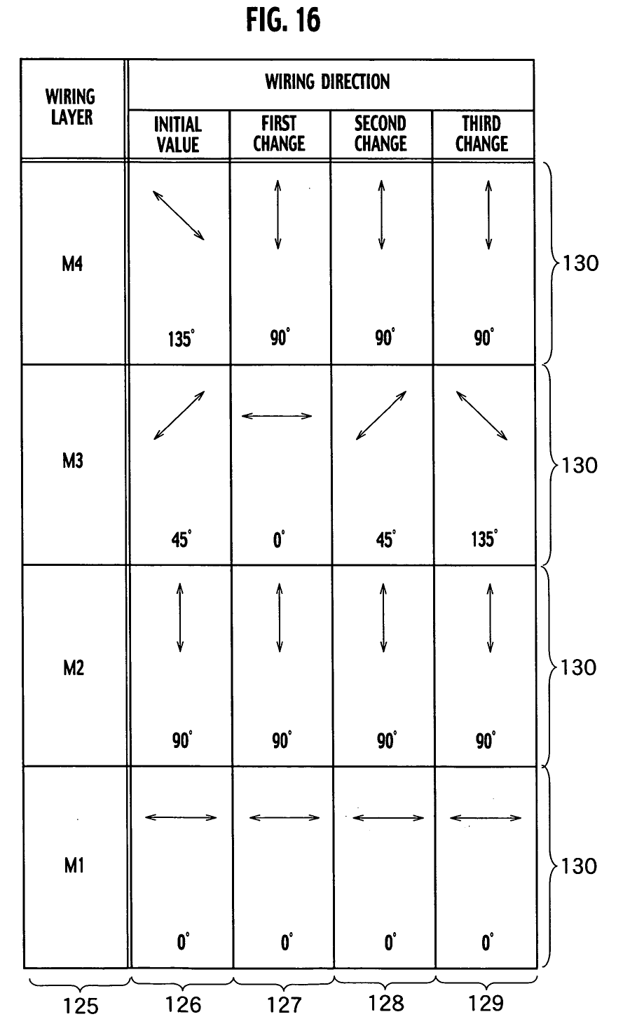

In step S15, the wiring directions for the wiring layers within the re-designated region 43 are changed. A database as shown in FIG. 16 is prepared ahead of time for the re-designated region 43. The database is searchable for wiring directions before and after changes based on wiring layers. The database includes records 130 searchable for wiring directions before and after changes based on designated wiring layers. The records 130 each include a wiring layer field 125, an initial wiring direction field 126, a first changed wiring direction field 127, a second changed wiring direction field 128, and a third changed wiring direction field 129. With this process, the first through third change is possible, and wiring directions for the first through fourth wiring layers before and after changes can be retrieved. The wiring directions for the first and second wiring layers do not change before and after changes. It can be seen that with the first change, the wiring direction for the third wiring layer changes to 0°, and the wiring direction for the fourth wiring layer changes to a 90° angle. Note that in the case of detour wires being developed with the first change, the wiring direction is changed based on the second change. With the second change, the wiring direction for the third wiring layer changes to a 45° angle. Furthermore, with the third change, the wiring direction for the third wiring layer changes to a 135° angle. The reasons for such changes are considered to be because the wiring direction for the frequently required wire located on a side of the layout plane 21 on which a megacell is not placed is parallel to that side or at a 90° angle as shown in FIG. 7. With the re-designated region 43, 90° angle wires are mainly needed and diagonal wires are not frequently needed. Horizontal wires are used for connecting to pins that can access above external block sides, and for connecting vertical wires to each other. Depending on the vertical position of the re-designated region 43, a 45° angle or a 135° angle may be more appropriate.

As described above, according to the embodiment of the present invention, a semiconductor integrated circuit including wires is designed within a practical processing time without the wire length being unnecessarily.

### SECOND EMBODIMENT

A design unit 1 of a semiconductor integrated circuit according to a second embodiment of the present invention, as shown in FIG. 1, includes a system design unit 2, a function design unit 3, a logic circuit design unit 4, and a layout design unit 5. The layout design unit 5 includes a cell placement unit 6, an initial region definition unit 7, a direction designation unit 8, a wiring unit 11, a detour determination unit 12, a region secondary definition unit 14, and a direction secondary changing unit 15.

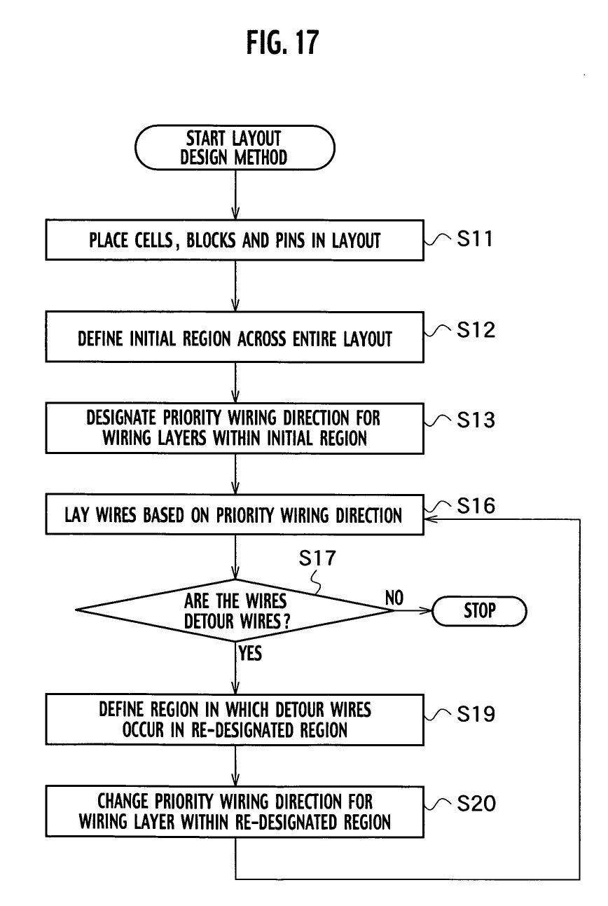

With a design method for the semiconductor integrated circuit according to the second embodiment of the present invention, as with the first embodiment, as shown in FIG. 2, in step S1, the system design unit 2 designs a system including the semiconductor integrated circuit. In step S2, the function design unit 3 designs functions required by the semiconductor integrated circuit based on the system. In step S3, the logic circuit design unit 4 designs logic circuits of the semiconductor integrated circuit based on these functions. In step S4, the layout design unit 5 designs semiconductor integrated circuit layout based on these logic circuits. This process based on the design method for the semiconductor integrated circuit is completed. Note that details of step S4 are given in the following description regarding the semiconductor integrated circuit layout design method of FIG. 17.

An overview of the layout design method for the semiconductor integrated circuit according to the second embodiment of the present invention is described.

To begin with, steps S11 through S13 of FIG. 17 are carried out in the same way as with steps S11 through S13 of the first embodiment. In other words, in step S11, the cell placement unit 6 of FIG. 1 places the transistors, cells and megacells 23 through 24 in the layout plane 21.

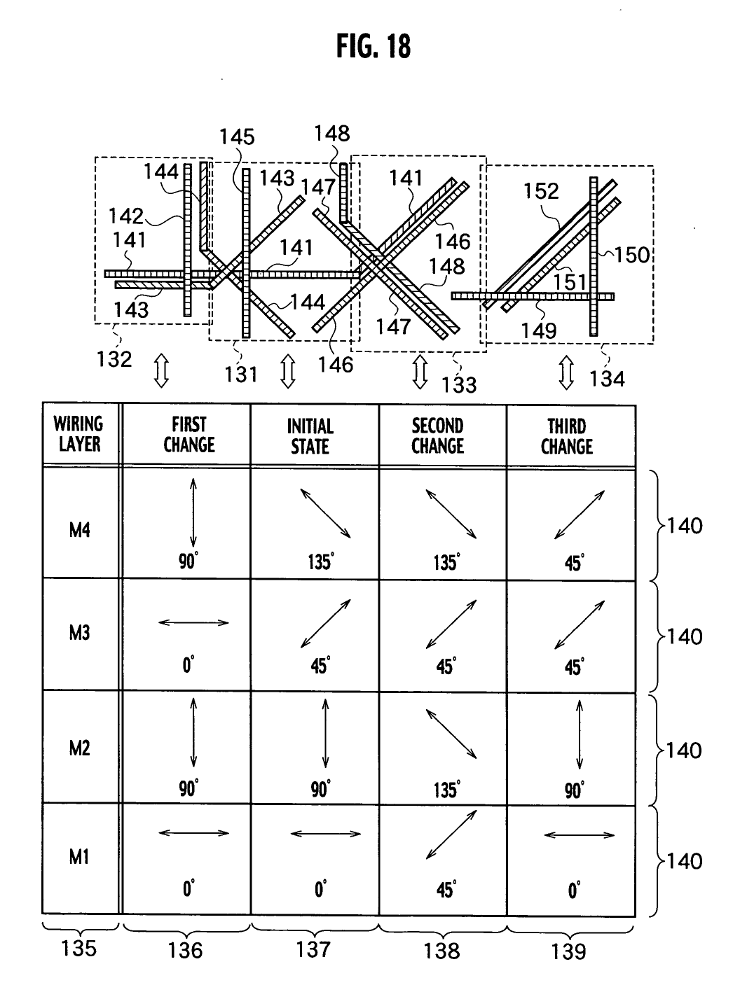

Next, in step S12, the initial region definition unit 7 defines an initial designated region 131 as shown in FIG. 18 across the entire layout plane 21.

In step S13, the direction designation unit 8 designates wiring directions for the wiring layers within the initial designated region 131 based on the database of FIG. 5.

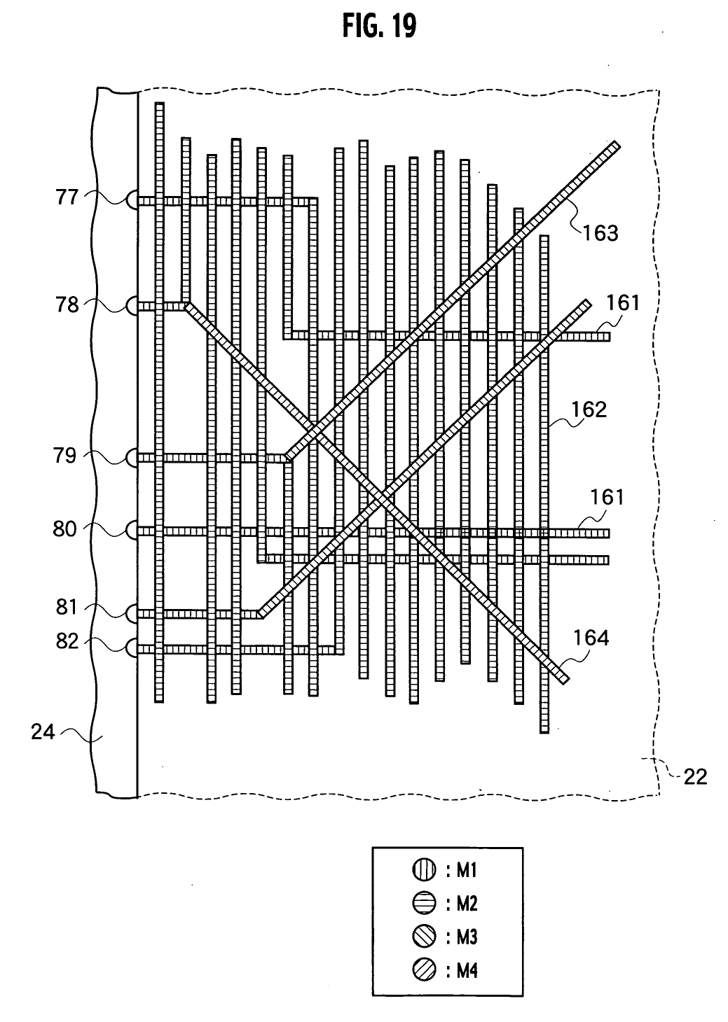

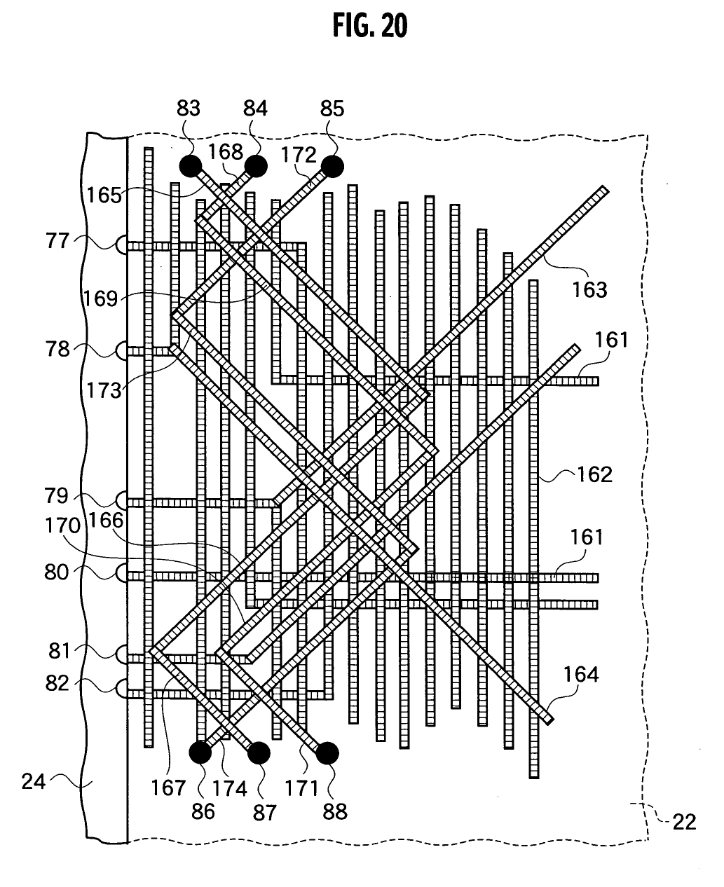

In step S16, as shown in FIG. 19, the wiring unit 11 forms initial wires 161 through 163 connecting pins 77 through 82 via the wiring layers based on the wiring directions. As a result, the allocated space of the second wiring layer in which wires with a 90° wiring direction are arranged is full with wires. On the other hand, the allocated space of the first, third and fourth wiring layers is available. As shown in FIG. 20, initial wires 165 through 167 connecting pin 83 and pin 87 are formed. Initial wires 168 through 171 connecting pin 84 and pin 88 are formed. Initial wires 172 through 174 connecting pin 85 and pin 86 are formed. Since wires with a 90° wiring direction cannot be arranged in the second wiring layer, the wires 166, 168, 170, 172, and 174 with a 45° diagonal wiring direction are arranged in the third wiring layer, and the wires 165, 167, 169, 171, and 173 with a 135° diagonal wiring direction are arranged in the fourth wiring layer.

In step S17, the detour determination unit 12 determines whether the initial wires are detour wires. If the wires are not detour wires, this process based on the layout design method for the semiconductor integrated circuit stops. Processing proceeds to step S19 if the initial wires are detour wires. The initial wires 165 through 167 connecting pin 83 and pin 87, the initial wires 168 through 171 connecting pin 84 and pin 88, and the initial wires 172 through 174 connecting pin 85 and pin 86 are determined to be detour wires.

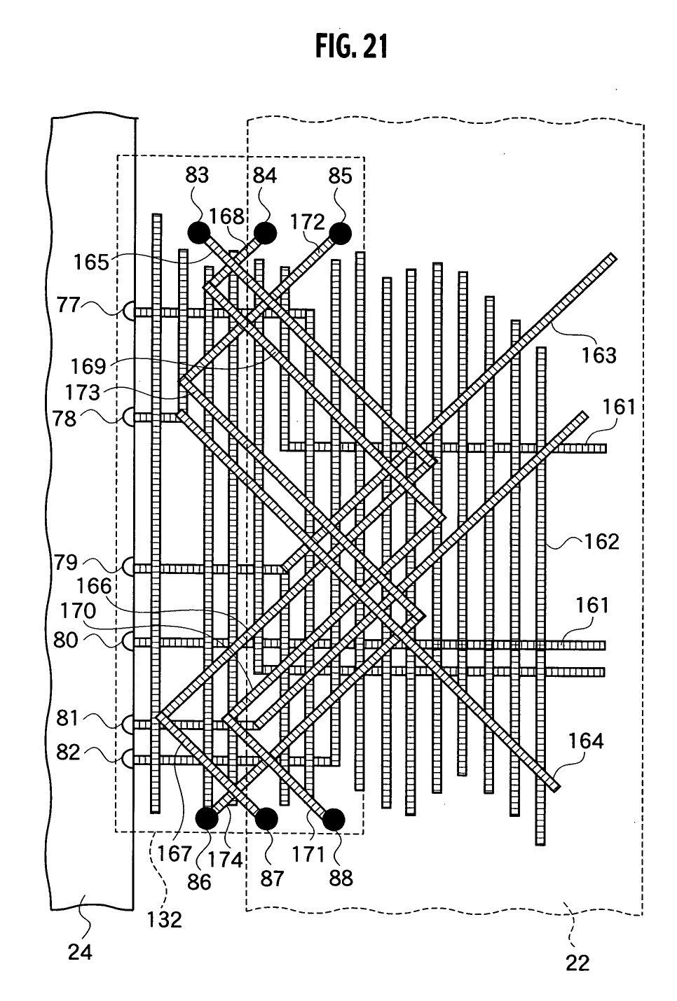

In step S19, as shown in FIGS. 18 and 21, the region secondary definition unit 14 designates the regions between the pins 83 through 88, which are connected to the detour wires within the initial designated region 131, to be the re-designated regions 132 through 134.

In step S20, the direction secondary changing unit 15 changes the wiring directions for the wiring layers within the re-designated regions 132, 133 and 134. A database a shown in FIG. 18 is prepared ahead of time. The database is searchable for wiring directions before and after changes based on wiring layers. The database includes records 140 searchable for wiring directions before and after changes based on designated wiring layers. The records 140 each include a wiring layer field 135, an initial state wiring direction field 137, a first change wiring direction field 136, a second change wiring direction field 138, and a third change wiring direction field 139. With this, the first through third changes are possible, and wiring directions for the first through fourth wiring layers before and after changes can be retrieved. Note that the number of wiring layers is not limited to four layers, and may be arbitrarily set according to the logic circuits of the semiconductor integrated circuit. It can be seen that with the first change, the wiring direction for the third wiring layer changes to 0°, and the wiring direction for the fourth wiring layer changes to a 90° angle. It can be seen that with the second change, the wiring direction for the first wiring layer changes to a 45° diagonal, and the wiring direction for the second wiring layer changes to a 135° diagonal. It can also be seen that with the third change, the wiring direction for the fourth wiring layer changes to a 45° diagonal.

A region in which connections of the 0°, 90° angle, 45° diagonal, and 135° diagonal wires are required at about the same frequency as each connections on average can be considered the largest region in the layout plane 21. Therefore, a state of all wiring directions are dispersed such that the wiring direction for each wiring layer is in a different direction is set as an initial wiring direction state. Specifically, in the case where there are four wiring layers with the same possible wiring direction, one wiring direction is allocated to one wiring layer. The largest region in the layout plane 21 is defined as the initial designated region 131.

It is determined that the wiring layers have a shortage in wire allocation space for wires without the main wiring directions of the detouring wires. Therefore, the wiring direction for a wiring layer in the re-designated regions 132 through 134, which designates a main wiring direction for detour wires as an initially set wiring direction, is changed to another wiring direction for wires that lack wire allocated space.

As shown in FIG. 21, in the case where the detour wires are mainly configured with 45° and 135° diagonal wires, it is determined that connection of either 0° or 90° angle wires is often required in the layout plane 21 between the starting point pin and the end point pin connected by detour wires; and that space of wiring layers in which either 0° or 90° angle wires are to be arranged is insufficient. Within the re-designated region 132, the wiring direction is then changed from the initial state to the first change.

In the case where the detour wires are mainly configured with 0° and 90° angle wires, it is determined that connection of either 45° or 135° diagonal wires is often required in the layout plane 21 between the starting point pin and the end point pin connected by detour wires, and that space of the wiring layers in which either 45° or 135° diagonal wires are to be arranged is insufficient. Within the re-designated region 133, the wiring direction is then changed from the initial state to the second change.

In the case where the detour wires are mainly configured with 0° angle and 90° angle wires, it is determined that connection of either 45° diagonal or 135° diagonal wires is often required in the layout plane 21 between the starting point pin and the end point pin connected by detour wires, and that space of the wiring layers in which either 45° diagonal or 135° diagonal wires are to be arranged is insufficient. Within the re-designated region 134, the wiring direction is then changed from the initial state to the third change.

Note that the database of FIG. 18 is not always needed. Instead of preparing a database, to begin with, the possibility of a connection request for each wiring direction is estimated by counting the wiring direction for each straight line connecting the starting point pin and the end point pin within the re-designated regions 132 through 134, where the closest allowable wiring direction to each straight line direction is chosen as that wiring direction for said each straight line. Next, in response to the mostly required wiring direction for each of the re-designated regions 132 through 134, the wiring direction for a wiring layer with little wiring demand is changed to a wiring direction with much wiring demand.

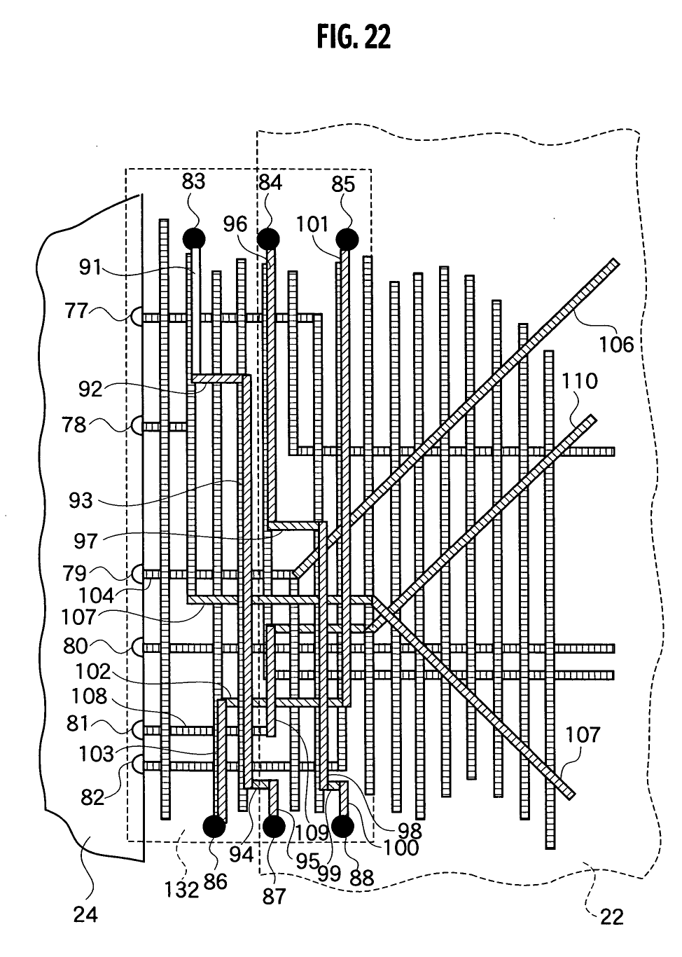

Processing then returns once again to step S16 of FIG. 17. In step S16, as shown in FIG. 22, based on the changed wiring direction, re-formed wires 91 through 95 connecting pin 83 and pin 87 via the third and the fourth wiring layer can be formed. Furthermore, re-formed wires 96 through 100 connecting pin 84 and pin 88 can be formed. Re-formed wires 101 through 103 connecting pin 85 and pin 86 can be formed. In step S17, if it can be determined that there is no detour wire within the re-designated regions 132 through 134, this process based on the layout design method stops.

As a result, shortening the wire length that has been lengthened due to detouring allows elimination of detour wires. Furthermore, when forming re-formed wires, since the space for re-formed wires is available space, the solution finding process for re-formed wire positions surely converges, and time needed for designing layout can be shortened.

Formation of re-formed wires should be based on either wiring directions before change or after change in peripheral areas of the re-designated regions 132 through 134. This is equivalent to providing gray zones based on the wiring direction for either the initial designated region 131 or the re-designated regions 132 through 134 to a part of the re-designated regions 132 through 134 when designating the re-designated regions 132 through 134. Within the region where the initial designated region 131 and the re-designated region 132 overlap, wires in the third wiring layer can be laid using both wiring directions at a 45° diagonal and at a 135° diagonal. The wires in the fourth wiring layer can be laid using both wiring directions at a 135° angle and at a 90° angle.

### THIRD EMBODIMENT

With a third embodiment of the present invention, the design unit 1 of the semiconductor integrated circuit of the first embodiment shown in FIG. 1 can be employed.

Furthermore, the third embodiment of the present invention can be implemented according to the design method for the semiconductor integrated circuit of the first embodiment shown in FIG. 2.

The third embodiment of the present invention can be implemented according to the layout design method for the semiconductor integrated circuit of the first embodiment shown in FIG. 3.

The layout design method for the semiconductor integrated circuit according to the third embodiment of the present invention is described based on a specific example.

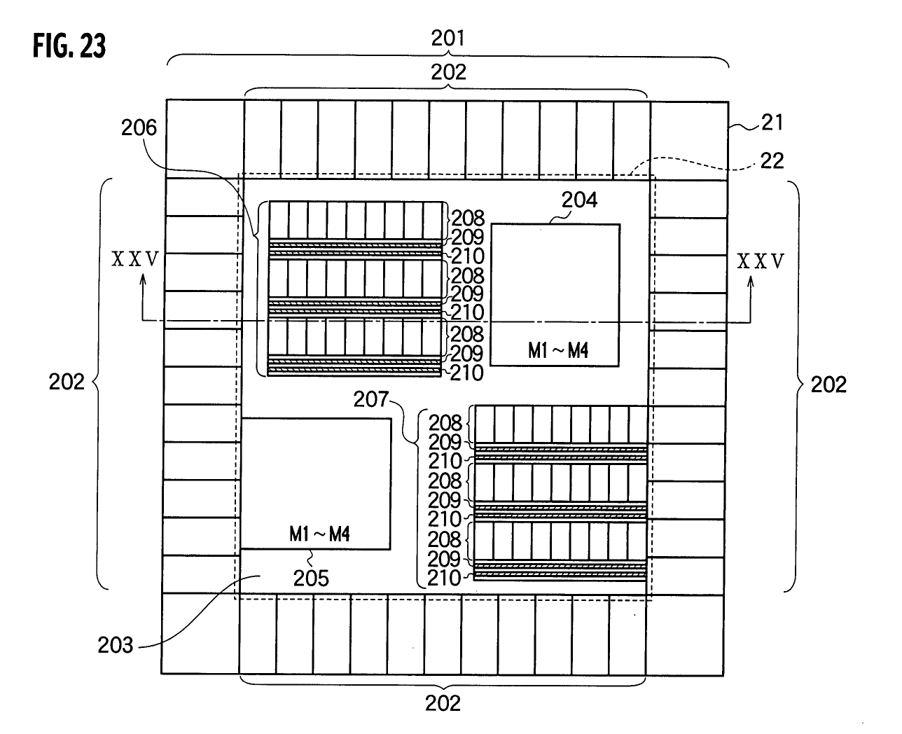

To begin with, in step S11 of FIG. 3, as shown in FIG. 23, I/O cells 202 and logic blocks 204 through 207 are placed in an oblong layout plane 21. The logic blocks 204 through 207 may be megacells 204 and 205 or standard cell arrays 206 and 207. A core area 203 is a region in which the logic blocks 204 through 207 can be placed and is adjacent to the I/O cells 202. The standard cell arrays 206 and 207 include standard cells 208, power source lines 209, and ground lines 210.

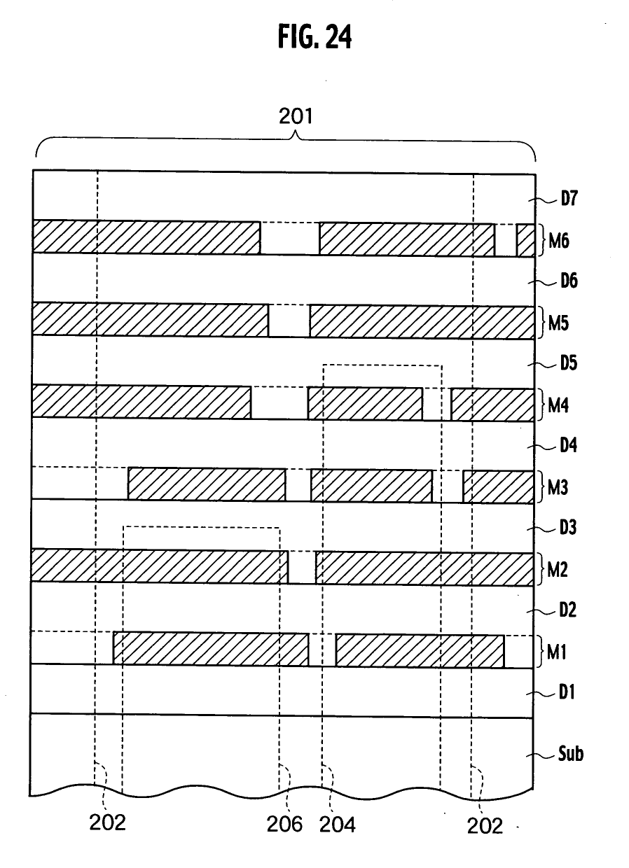

As shown in a cross-section of the layout plane 21 of the semiconductor integrated circuit of FIG. 24, the semiconductor integrated circuit includes a semiconductor substrate Sub, multiple interlayer insulator films D1 through D7, and multiple wiring layers M1 through M6. The multiple wiring layers M1 through M6 each have multiple wires. The standard cell array 206 employs the wiring layers M1 and M2 for the wires within the power source lines 209, the ground lines 210, and the standard cell arrays 206. As a result, the wiring layers M3 through M6 over the standard cell array 206 can use external wires of the standard cell array 206, wires between the logic blocks 204 through 207, and wires between the I/O cells 202 and the logic blocks 204 through 207. The megacell 204 uses the wiring layers M1 through M4 for internal wiring. As a result, the wiring layers M5 and M6 over the standard cell array 204 can use external wires of the standard cell array 204, the wires between the logic blocks 204 through 207, and the wires between the I/O cells 202 and the logic blocks 204 through 207. The I/O cells 202 use the wiring layers M1 through M6 for internal wiring. As a result, the wiring layers over the I/O cells 202 cannot use the wires between the logic blocks 204 through 207 and the wires between the I/O cells 202 and the logic blocks 204 through 207.

Next, in step S12, as shown in FIG. 23, an initial designated region 22 is defined across the entire core area 22 in which wires can be laid in the wiring layers M1 through M6.

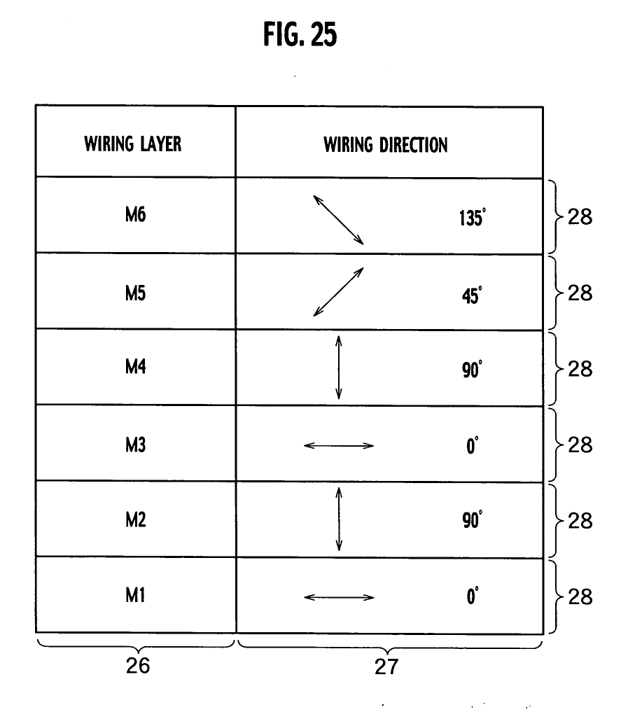

In step S13, wiring directions are designated for the wiring layers M1 through M6 within the initial designated region 22. Specifically, as shown in FIG. 25, for example, a database searchable for wiring direction based on the wiring layers is created. Accordingly, a wiring direction of 0° (horizontal) from the first wiring layer M1 can be retrieved. Similarly, a wiring direction of a 90° angle (vertical) from the second wiring layer M2 can be retrieved. A wiring direction of 0° (horizontal) from the third wiring layer M3 can be retrieved. A wiring direction of a 90° angle (vertical) from the fourth wiring layer M4 can be retrieved. A wiring direction of a 45° diagonal from the fifth wiring layer M5 can be retrieved. A wiring direction of a 135° diagonal from the sixth wiring layer M6 can be retrieved. According to such retrievals, wires can be arranged in the first through sixth wiring layers M1 through M6 with the retrieved wiring directions.

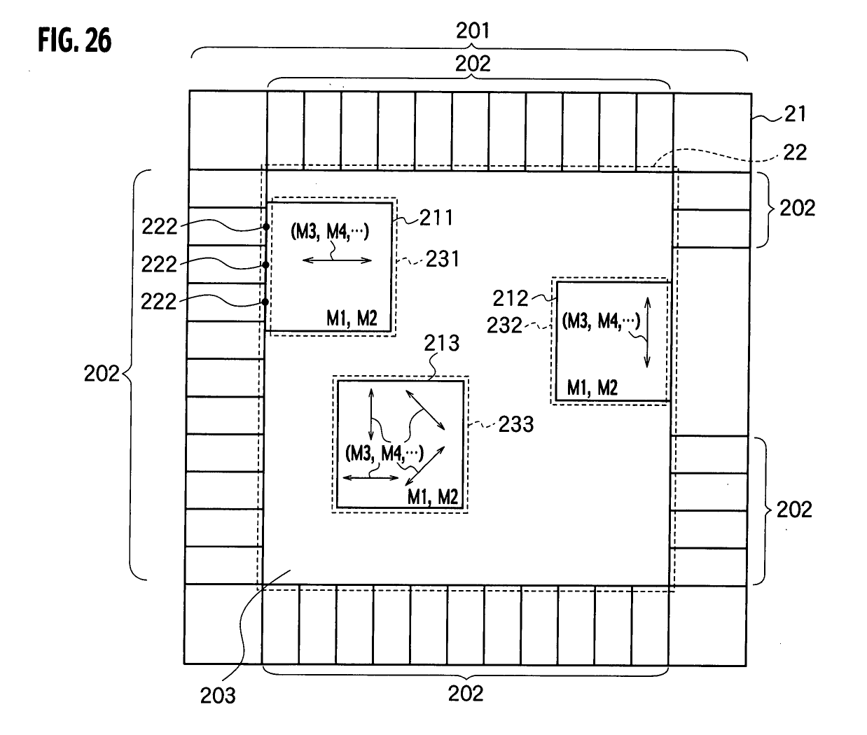

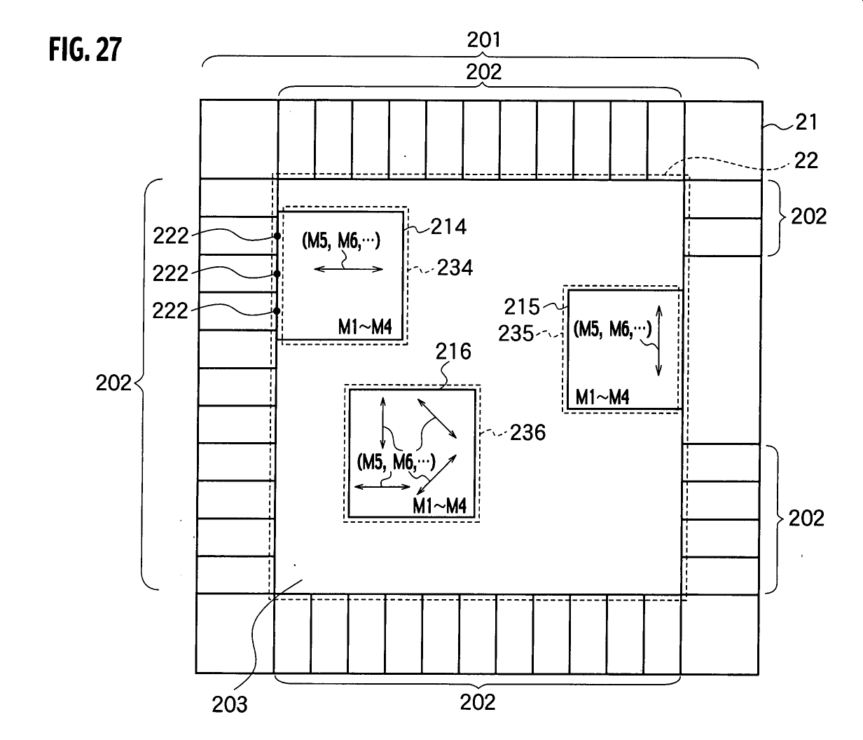

In step S14, as shown in FIGS. 26 and 27, re-designated regions 231 through 236, 219, 220 and 225 are designated within the initial designated region 22.

As shown in FIG. 26, a logic block 211 is set as a standard cell array. The logic block 211 is in contact with a side of a core area 203, and is in contact with I/O cells 202. The re-designated region 231 is provided within an internal region of the logic block 211. The re-designated region 231 is in contact with I/O cells 202. The I/O cells 202 each includes a pin 222, which becomes a starting point for a wire. The wiring layers M1 and M2 within the re-designated region 231 are used for internal wiring of the standard cell array. In the remaining wiring layers M3 through M6, wires are arranged in directions as given in FIG. 25. However, since wires connecting to the pins 222 are necessary within the re-designated region 231, wires at 0° (horizontal), which is perpendicular to a side of the core area 203, are considered to be heavily used. Therefore, in step S15, the wiring direction for at least one of the wiring layers M3 through M6 within the re-designated region 231 is changed to 0° (horizontal).

A logic block 212 is set as a standard cell array. The logic block 212 is in contact with a side of the core area 203, but is not in contact with any I/O cells 202. The re-designated region 232 is provided within an internal region of the logic block 212, and is not in contact with any I/O cells 202. The wiring layers M1 and M2 within the re-designated region 232 are used for internal wiring of the standard cell array. In the remaining wiring layers M3 through M6, wires are arranged in directions as given in FIG. 25. However, wires at 0° (horizontal), which is perpendicular to a side of the core area 203, are not considered to be heavily used within the re-designated region 232. On the other hand, wires at a 90° angle (vertical), which is parallel to a side of the core area 203, are considered to be heavily used. Therefore, in step S15, the wiring direction for at least one of the wiring layers M3 through M6 within the re-designated region 232 is changed to a 90° angle (vertical).

A logic block 213 is set as a standard cell array. The logic block 213 is not in contact with any side of the core area 203, and is also not in contact with any I/O cells 202. The re-designated region 233 is provided within an internal region of the logic block 213, overlaps with the logic block 213, and is not in contact with any I/O cells 202. The wiring layers M1 and M2 within the re-designated region 233 are used for internal wiring of the standard cell array. In the remaining wiring layers M3 through M6, wires are arranged in directions as given in FIG. 25. With the re-designated region 233, it is considered sufficient if the wiring direction can be changed according to the state of wires surrounding the re-designated region 233. Therefore, in step S15, the wiring direction for at least one of the wiring layers M3 through M6 within the re-designated region 233 is changed appropriately.

As shown in FIG. 27, a logic block 214 is set as a megacell. The logic block 214 is in contact with a side of the core area 203, and is in contact with I/O cells 202. The re-designated region 234 is provided within an internal region of the logic block 214, and is in contact with I/O cells 202. The I/O cells 202 each includes a pin 222, which becomes a starting point for a wire. The wiring layers M1 through M4 within the re-designated region 234 are used for internal wiring of the megacell. In the remaining wiring layers M5 and M6, wires are arranged in directions defined in step S13. However, since wires connecting to the pins 222 are necessary within the re-designated region 234, wires at 0° (horizontal), which is perpendicular to a side of the core area 203, are considered to be heavily used. Therefore, in step S15, the wiring direction for at least one of the wiring layers M5 and M6 within the re-designated region 234 is changed to 0° (horizontal).

A logic block 215 is set as a megacell. The logic block 215 is in contact with a side of the core area 203, but is not in contact with any I/O cells 202. The re-designated region 235 is provided within an internal region of the logic block 215, but is not in contact with any I/O cells 202. The wiring layers M1 through M4 within the re-designated region 235 are used for internal wiring of the megacell. In the remaining wiring layers M5 and M6, wires are arranged in directions defined in step S13. However, wires at 0° (horizontal), which is perpendicular to a side of the core area 203, are not considered to be heavily used within the re-designated region 235. On the other hand, wires at a 90° angle (vertical), which is parallel to a side of the core area 203, are considered to be used many times. Therefore, in step S15, the wiring direction for at least one of the wiring layers M5 and M6 within the re-designated region 235 is changed to a 90° angle (vertical).

A logic block 216 is set as a megacell. The logic block 216 is not in contact with any side of the core area 203, and is also not in contact with any I/O cells 202. The re-designated region 236 is provided within an internal region of the logic block 216, overlaps with the logic block 216, and is not in contact with any I/O cells 202. The wiring layers M1 through M4 within the re-designated region 236 are used for internal wiring of the megacell. In the remaining wiring layers M5 and M6, wires are arranged in directions defined in step S13. Within the re-designated region 236, it is considered sufficient that the wiring direction can be changed according to the state of wires surrounding the re-designated region 236. Therefore, in step S15, the wiring direction for at least one of the wiring layers M5 and M6 within the re-designated region 236 is changed.

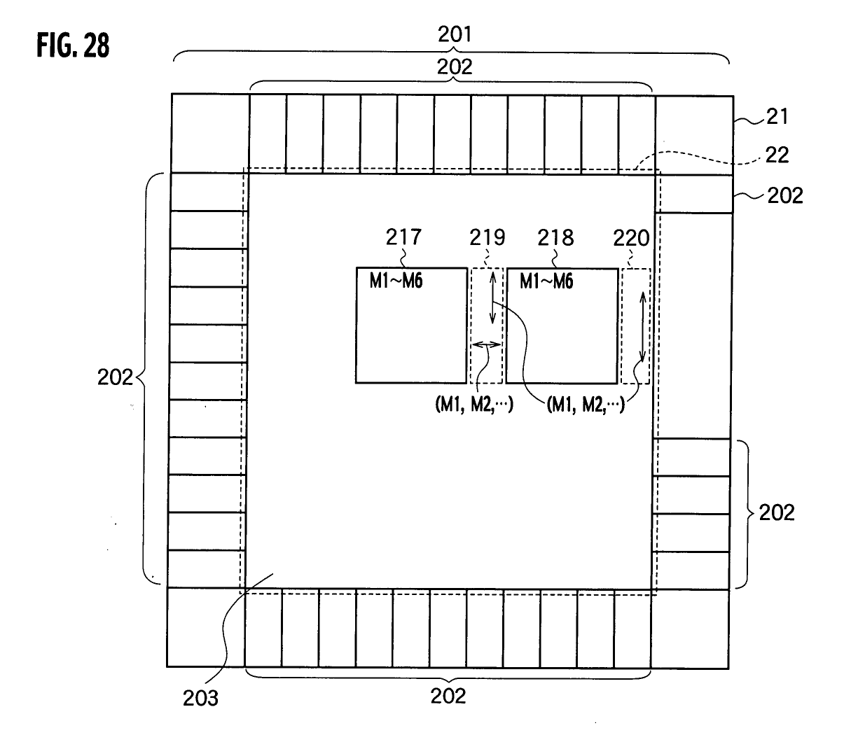

As shown in FIG. 28, logic blocks 217 and 218 are set as megacells. The logic blocks 217 and 218 are placed near each other. The sides of the logic blocks 217 and 218 face each other. The re-designated region 219 is provided between the logic blocks 217 and 218. The wiring layers M1 through M6 within the re-designated regions 217 and 218 are used for internal wiring of the megacells. In the wiring layers M1 through M6 within the re-designated region 219, wires are arranged in directions defined in step S13. However, since wires connecting to the logic blocks 217 and 218 are necessary within the re-designated region 219, wires at 0° (horizontal), which is perpendicular to a side that faces the logic blocks 217 and 218, are considered to be heavily used. Furthermore, wires vertically connecting regions above and below the respective logic blocks 217 and 218 are required. Above the logic blocks 217 and 218, wiring layers cannot exist for wires vertically passing over the logic blocks 217, 218. Therefore, in order to vertically connect the logic blocks 217 and 218, within the re-designated region 219, wires at a 90° angle (vertical), which is parallel to a side that faces the logic blocks 217 and 218, are considered to be used many times. Therefore, in step S15, the wiring direction for at least one of the wiring layers M1 through M6 within the re-designated region 219 is changed to a 90° angle (vertical).

The logic block 218 is placed near a side of the core area 203. The logic block 218 side faces the nearest side of the core area 203. A re-designated region 220 is provided between the sides of the facing logic block 218 and the core area 203. The re-designated region 220 is a nearby region external to the logic block 218, and is a peripheral internal region of the core area 203. Some I/O cells 202 placed on the core area 203 side that faces the logic block 218 side. Alternatively, I/O cells may not be provided. Wires vertically connecting regions above and below the respective logic blocks 217 and 218 are required. Above the logic block 218, wiring layers cannot exist for wires vertically passing over the logic block 218. Therefore, in order to vertically connect the logic block 218, within the re-designated region 220, wires at a 90° angle (vertical), which is parallel to the facing logic block 218 side and core area 203 side, are considered to be heavily used. Therefore, in step S15, the wiring direction for at least one of the wiring layers Ml through M6 within the re-designated region 220 is changed to a 90° angle (vertical).

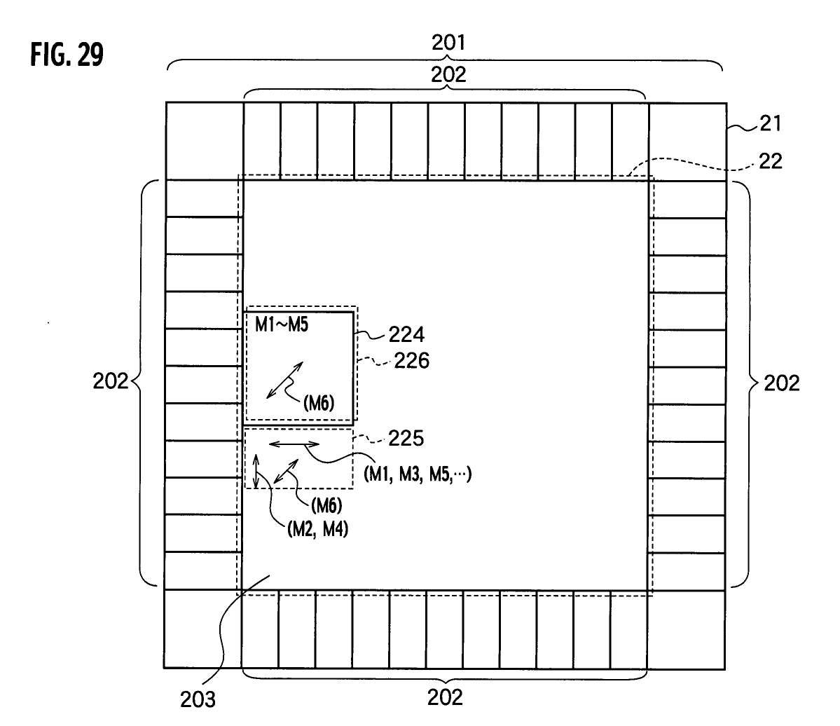

As shown in FIG. 29, a logic block 224 is set as a megacell. The logic block 224 is in contact with a side of the core area 203, and is in contact with I/O cells 202. A re-designated region 225 is a nearby external region to the logic block 224, a peripheral internal region of the core area 203, and is in contact with I/O cells 202, which are in contact with a core area 203 side. The wiring layers M1 through M5 within the re-designated region 224 are used for internal wiring of the megacells. In the wiring layers M1 through M6 within the re-designated region 225, wires are arranged in directions defined in step S13. However, with the re-designated region 225, wires parallel to the logic block 224 side in contact with the re-designated region 225 are required. Therefore, wires at 0° (horizontal), which is perpendicular to the core area 203 side in contact with the re-designated region 225, are considered to be heavily used. Furthermore, wires that start at the re-designated region 225 and cross over the logic block 224 are necessary. The direction of the wiring layer M6 at the re-designated region 226 needs to be changed to a 45° diagonal. Therefore, in step S15, the wiring direction for at least one of the wiring layers M1 through M6 within the re-designated region 225 is changed to 0° (horizontal). Furthermore, the wiring direction for at least one of the wiring layers M5 and M6 within the re-designated region 235 is changed to a 45° diagonal.

In step S16, for every wiring layer M1 through M6, wires connecting differing logic blocks and connecting an I/O cell and a logic block are formed in accordance with the wiring directions for the initial designated region 22 and the re-designated regions 231 through 236, 219, 220 and 225.

In step S17, it is determined whether the formed wires are detour wires. Determination may be carried out in the same way as with the first embodiment.

In step S18, it is determined whether it is necessary to re-designate a re-designated region. Determination may be carried out in the same way as with the first embodiment.

In this manner, multiple wiring directions are available for one wiring layer, and thus many wiring layers may be used for the wiring directions most required for connection. A short wire length can be achieved, and the wire length does not become longer than necessary. Furthermore, since the connection rate improves based on the condition of the priority wiring direction for each region of each wiring layer being fixed, wires can be designed within a practical processing time.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein.

1. A semiconductor integrated circuit comprising:
a plurality of first wires running in a first direction of 0°, a 45° diagonal, a 90° angle and a 135° diagonal in a subject area disposed in a designated wiring layer in a multilevel interconnection; and
a plurality of second wires running in a second direction of 0°, the 45° diagonal, the 90° angle and the 135° diagonal in a wiring region other than the designated region in the designated wiring layer.

2. The semiconductor integrated circuit of claim 1, wherein the subject area includes a plurality of logic blocks placed in the core area, and the first wires and the second wires connect the logic blocks.

3. The semiconductor integrated circuit of claim 1, wherein the subject area includes a logic block in a core area, and the logic block is a megacell, a standard cell array or an I/O cell.

4. The semiconductor integrated circuit of claim 1, wherein the subject area includes between two logic blocks, and the first direction is a direction parallel to sides of two logic blocks on both sides of the subject area.

5. The semiconductor integrated circuit of claim 1, wherein the subject area includes a nearby external region to a plurality of logic blocks and a peripheral internal region of a core area, and the first direction is a direction parallel to sides of logic blocks on both sides of the subject area, and a side of the core area.

6. The semiconductor integrated circuit of claim 1, wherein the subject area includes an internal region of a logic block in contact with a side of a core area, and the first direction is a direction parallel to the side of the core area.

7. The semiconductor integrated circuit of claim 1, wherein the subject area includes an internal region of a logic block in contact with a side of a core area, the logic block is in contact with I/O cells in contact with the side of the core area, and the first direction is a direction perpendicular to the side of the core area.

8. The semiconductor integrated circuit of claim 1, wherein the subject area includes a nearby external region to a logic block in contact with a side of a core area, the logic block is in contact with I/O cells in contact with the side of the core area, and the first direction is a direction perpendicular to the side of the core area.

9. A method for routing a wire within a semiconductor integrated circuit comprising:
placing a logic block in a layout plane that includes a plurality of wiring layers;
defining an initial area across the entire layout plane;
designating a wiring direction for each of the wiring layers within the initial area;
defining a re-designated region within the initial area;
changing the wiring direction for each of the wiring layers in the re-designated region; and
forming wires in the wiring layers based on the wiring directions.

10. The method of claim 9, further comprising:
determining whether one of the wires is a detour wire; and
changing the wiring direction and forming wires again when one of the wires is the detour wire.

11. The method of claim 10, wherein the wire is determined as the detour wire when a length of the wire is equal to or greater than a product of the square root of two and a distance between pins connected by the wire, and if there is a wire branch point along the wire, when a length of the wire is equal to or greater than a product of the square root of two and a distance between a pin and the wire branch point or a length of the wire is equal to or greater than a product of the square root of two and a distance between the wire branch points, if there are a plurality of wire branch points along the wire.

12. The method of claim 10, further comprising:
determining whether to re-designate the re-designated region when a wire is a detour wire; and
when re-designating the re-designated region is necessary, designating the re-designated region is carried out again.

13. The method of claim 12, wherein determining whether re-designating the re-designated region is necessary is to determine whether the detour wire is outside of the re-designated region.

14. A method for routing a wire within a semiconductor integrated circuit comprising:
placing a logic block in a layout plane that includes a plurality of wiring layers;
defining an initial area across the entire layout plane;
designating a wiring direction for each of the wiring layers within the initial area;
forming initial wires in the wiring layers based on the wiring directions;
determining whether the initial wires are detour wires;
designating a region between pins that are connected by detour wires within the initial area as a re-designated region when the initial wires are the detour wires;
changing the wiring direction for each of the wiring layers in the re-designated region; and
forming re-formed wires in the wiring layers based on the changed wiring directions.

15. The method of claim 14, wherein determination of whether the initial wires are detour wires is to determine whether the sum of the length of each of the initial wires is equal to or greater than the product of the square root of two and the distance between the connected pins.

16. The method of claim 14, wherein formation of the re-formed wires is carried out based on one of the wiring directions before change and after change in a peripheral area of the re-designated region.

17. A computer program product for routing a wire within a semiconductor integrated circuit comprising:
instructions for placing a logic block in a layout plane that includes a plurality of wiring layers;
instructions for defining an initial area across the entire layout plane;
instructions for designating a wiring direction for each of the wiring layers within the initial area;
instructions for defining a re-designated region within the initial area;
instructions for changing the wiring direction for each of the wiring layers in the re-designated region; and
instructions for forming wires in the wiring layers based on the wiring directions.

18. A computer program product for routing a wire within a semiconductor integrated circuit comprising:
instructions for placing a logic block in a layout plane that includes a plurality of wiring layers;
instructions for defining an initial area across the entire layout plane;
instructions for designating a wiring direction for each of the wiring layers within the initial area;
instructions for forming initial wires in the wiring layers based on the wiring directions;
instructions for determining whether the initial wires are detour wires;
instructions for designating a region between pins that are connected by detour wires within the initial area as a re-designated region when the initial wires are the detour wires;
instructions for changing the wiring direction for each of the wiring layers in the re-designated region; and
instructions for forming re-formed wires in the wiring layers based on the changed wiring directions.
